(19) United States
(12) Patent Application Publication
(10) Pub. No.: US 2022/0228945 A1
(43) Pub. Date: Jul. 21, 2022

(54) VALVE SEAL ASSEMBLIES, VALVE TESTING MACHINES INCLUDING THE SAME, AND ASSOCIATED METHODS

(71) Applicant: Climax Portable Machine Tools, Inc., Newberg, OR (US)

(72) Inventors: Raymond James Jentges, Newberg, OR (US); Scott J. Thiel, Sherwood, OR (US)

(21) Appl. No.: 17/557,964

(22) Filed: Dec. 21, 2021

Related U.S. Application Data
(60) Provisional application No. 63/138,008, filed on Jan. 15, 2021.

(51) Int. Cl. G01M 3/28; F16K 37/00

(52) U.S. Cl. CPC G01M 3/2876; F16K 37/0083

(57) ABSTRACT

Valve seal assemblies, valve testing machines including the same, and associated methods. A valve seal assembly includes a seal plate structure and a force transfer member. The seal plate structure includes a base seal plate, and additionally may include an expansion adapter seal plate. The seal plate structure may include a socket receiver, and the force transfer member may include a socket head that is received within the socket receiver. The force transfer member may define a force transfer member fluid channel, and the base seal plate may define at least a portion of a seal plate fluid channel that is at aligned with the force transfer member fluid channel. A method of utilizing a valve testing machine includes configuring a seal plate structure for use to test a valve and forming a fluid-tight seal between the sealing flange and the valve seal surface.

### RELATED APPLICATION

This application claims priority to U.S. Provisional Patent Application No. 63/138,008, entitled “VALVE SEAL ASSEMBLIES AND VALVE TESTING MACHINES INCLUDING THE SAME,” filed on Jan. 15, 2021, the disclosure of which is hereby incorporated by reference.

### FIELD

The present disclosure relates to valve seal assemblies, valve testing machines including the same, and associated methods.

### BACKGROUND

Valve testing machines may be utilized to verify and/or characterize the performance of pressure relief valves by supplying a pressurized fluid flow to a valve inlet of the valve at a controlled pressure. In some examples, the valve testing machines form a fluid-tight seal with the valve via a clamping force that is applied between a sealing flange of the valve and a seal plate of the valve testing machine. However, variations in the sizes of the valves to be tested may necessitate providing a plurality of seal plates of correspondingly various sizes. Additionally, variations in the thickness of the sealing flange may diminish the robustness of the fluid seal between the sealing flange and the seal plate. Thus, there exists a need for improved valve seal assemblies and valve testing machines including the same.

### SUMMARY

Valve seal assemblies, valve testing machines including the same, and associated methods are disclosed herein. A valve seal assembly for operatively coupling a valve to a valve testing machine includes a seal plate structure and a force transfer member. The seal plate structure includes a valve seal surface configured to engage a sealing flange of the valve to form a fluid-tight seal with the sealing flange. The force transfer member includes a force transfer member body configured to be operatively coupled to a force exerting mechanism of the valve testing machine. The seal plate structure includes a base seal plate with a base seal plate first surface and a base seal plate second surface opposite the base seal plate first surface. The base seal plate second surface includes a base seal plate sealing interface.

In some examples, the seal plate structure additionally includes an expansion adapter seal plate with an expansion adapter seal plate first surface and an expansion adapter seal plate second surface opposite the expansion adapter seal plate first surface. The base seal plate sealing interface is configured to form a fluid-tight seal with the expansion adapter seal plate first surface. The expansion adapter seal plate second surface includes an expansion adapter seal plate sealing interface that is configured to form a fluid-tight seal with the sealing flange and/or with another component of the seal plate structure.

In some examples, one of the seal plate structure and the force transfer member includes a socket receiver opposite the valve seal surface, and the other of the seal plate structure and the force transfer member includes a socket head extending from the force transfer member body. During operative use of the valve testing machine, the socket head is received within the socket receiver to convey a sealing force from the force exerting mechanism to the seal plate structure. The valve seal assembly is configured to convey a pressurized fluid to a valve inlet of the valve during operative use of the valve testing machine. The force transfer member defines a force transfer member fluid channel for conveying the pressurized fluid through the force transfer member, and the base seal plate defines at least a portion of a seal plate fluid channel extending through at least a portion of the seal plate structure. During operative use of the valve testing machine, the force transfer member fluid channel is at least partially aligned with the seal plate fluid channel to permit the pressurized fluid to flow from the fluid inlet into the valve inlet via the force transfer member fluid channel and the seal plate fluid channel.

A method of utilizing a valve testing machine to test a valve includes configuring the seal plate structure for use to test the valve and forming the fluid-tight seal between the sealing flange and the valve seal surface. In some examples, the configuring the seal plate structure includes assembling the expansion adapter seal plate to the base seal plate.

### BRIEF DESCRIPTION OF THE DRAWINGS

FIG. 1 is a schematic cross-sectional side elevation view illustrating examples of valve testing machines including valve seal assemblies according to the present disclosure.

FIG. 2 is a schematic fragmentary cross-sectional side elevation view illustrating an example of a valve seal assembly including a base seal plate that defines a valve seal surface according to the present disclosure.

FIG. 3 is a schematic fragmentary cross-sectional side elevation view illustrating an example of a valve seal assembly including a reduction adapter seal plate that defines a valve seal surface according to the present disclosure.

FIG. 4 is a schematic cross-sectional side elevation view illustrating an example of a valve seal assembly with a base seal plate that is angled relative to a force transfer member by a threshold offset angle according to the present disclosure.

FIG. 5 is a top front side isometric view of a first example of a valve seal assembly operatively coupling a valve to a valve testing machine according to the present disclosure.

FIG. 6 is a cross-sectional side elevation view of the valve seal assembly, the valve, and the valve testing machine of FIG. 5.

FIG. 7 is a fragmentary cross-sectional top front side isometric view of the valve seal assembly, the valve, and the valve testing machine of FIGS. 5-6.

FIG. 8 is a fragmentary cross-sectional top front side isometric view of the valve seal assembly and the valve testing machine of FIGS. 5-7.

FIG. 9 is a cross-sectional side elevation view of the valve seal assembly and the valve testing machine of FIGS. 5-8.

FIG. 10 is an exploded cross-sectional top rear isometric view of the valve seal assembly of FIGS. 5-9.

FIG. 11 is an exploded cross-sectional bottom rear isometric view of the valve seal assembly of FIGS. 5-10.

FIG. 12 is a top front side isometric view of a second example of a valve seal assembly operatively coupled to a valve testing machine according to the present disclosure.

FIG. 13 is a cross-sectional top rear isometric view of the valve seal assembly and the valve testing machine of FIG. 12.

FIG. 14 is a cross-sectional side elevation view of the valve seal assembly and the valve testing machine of FIGS. 12-13.

FIG. 15 is an exploded cross-sectional top rear isometric view of the valve seal assembly of FIGS. 12-14.

FIG. 16 is an exploded cross-sectional bottom rear isometric view of the valve seal assembly of FIGS. 12-15.

FIG. 17 is an exploded top front isometric view of a seal plate structure of a third example of a valve seal assembly according to the present disclosure.

FIG. 18 is a cross-sectional front elevation view of the seal plate structure of FIG. 17 in an assembled configuration.

FIG. 19 is a cross-sectional front side isometric view of the seal plate structure of FIGS. 17-18.

FIG. 20 is a flowchart depicting examples of methods of utilizing a valve seal assembly according to the present disclosure.

### DESCRIPTION

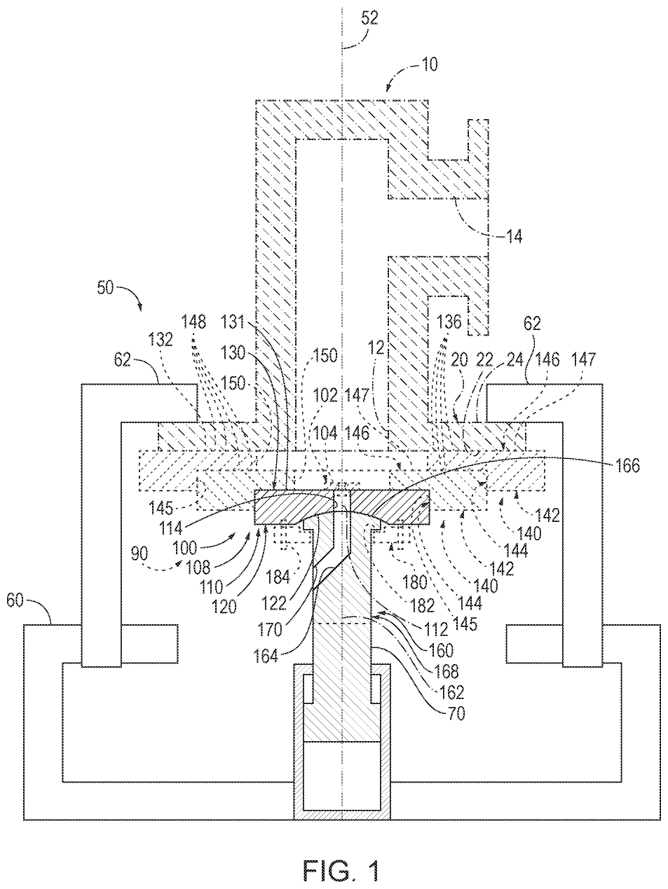

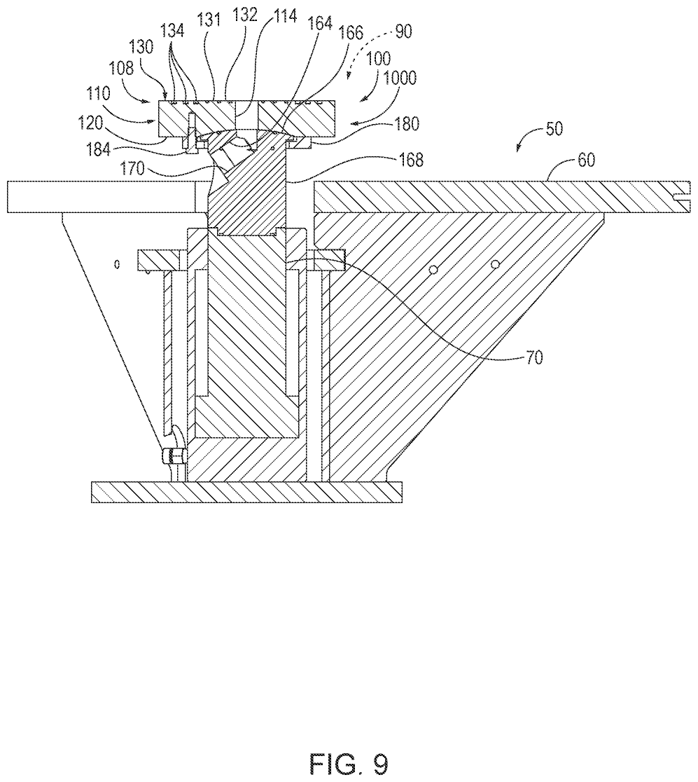

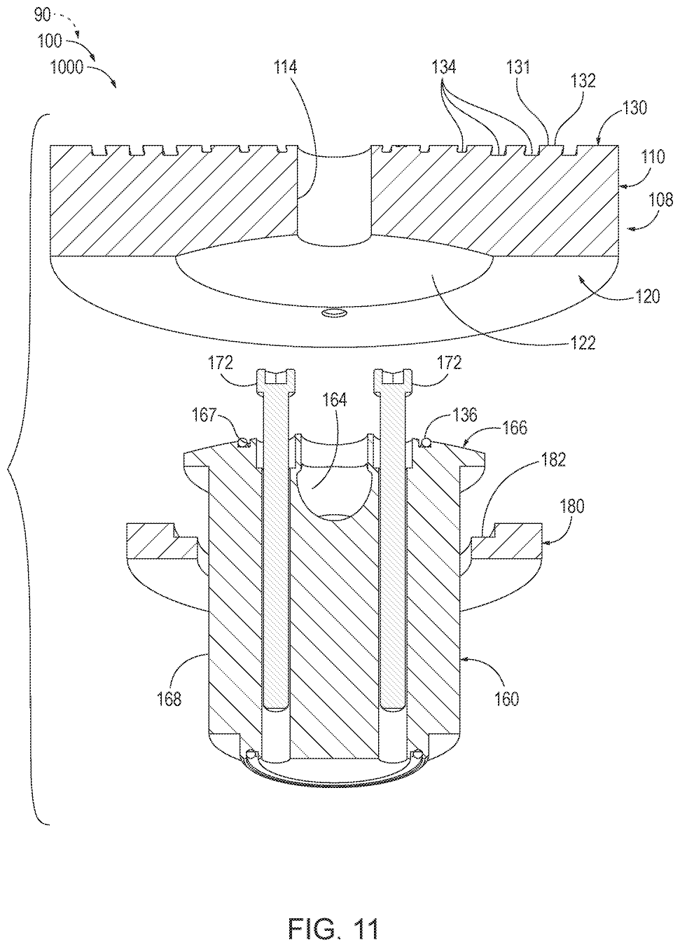

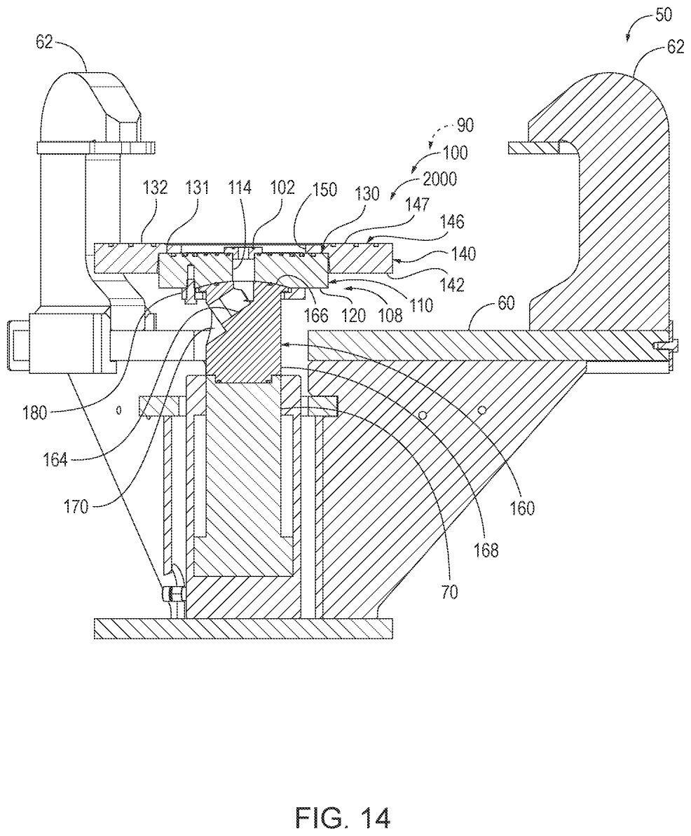

FIGS. 1-20 provide examples of valve seal assemblies 100 of valve testing machines 50 that utilize valve seal assemblies 100, and/or of methods 200 of utilizing valve seal assemblies 100, according to the present disclosure. Elements that serve a similar, or at least substantially similar, purpose are labeled with like numbers in each of FIGS. 1-20, and these elements may not be discussed in detail herein with reference to each of FIGS. 1-20. Similarly, all elements may not be labeled in each of FIGS. 1-20, but reference numerals associated therewith may be utilized herein for consistency. Elements, components, and/or features that are discussed herein with reference to one or more of FIGS. 1-20 may be included in and/or utilized with any of FIGS. 1-20 without departing from the scope of the present disclosure. In general, elements that are likely to be included in a particular embodiment are illustrated in solid lines, while elements that are optional are illustrated in dashed lines. However, elements that are shown in solid lines may not be essential and, in some embodiments, may be omitted without departing from the scope of the present disclosure.

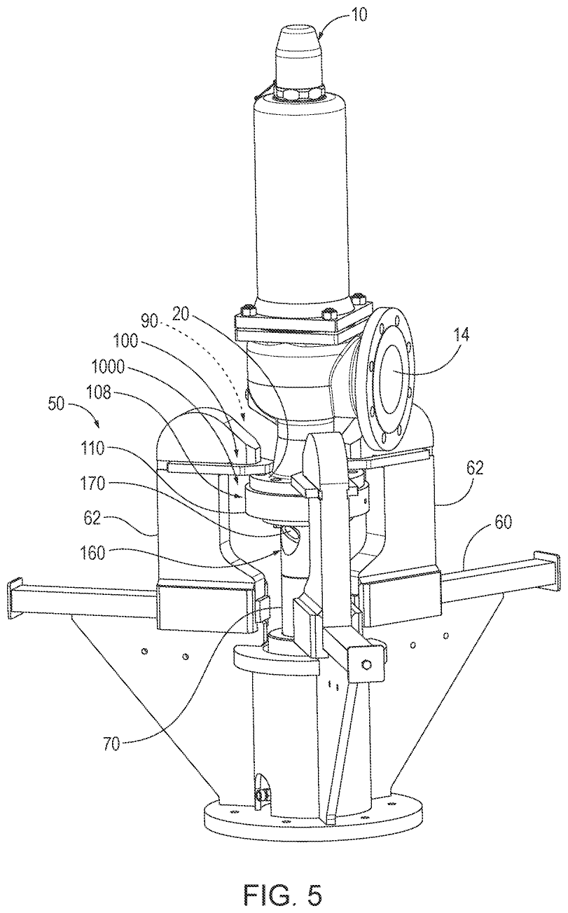

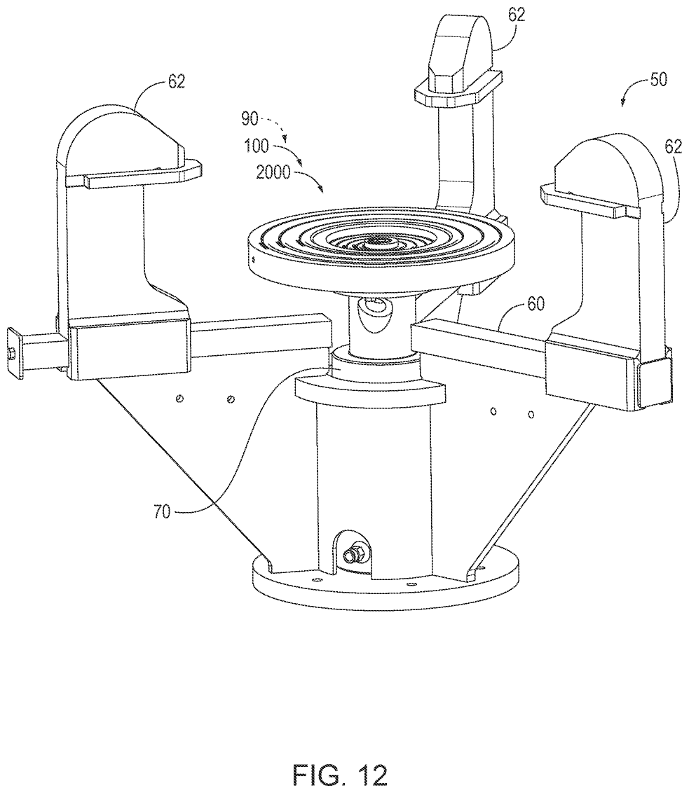

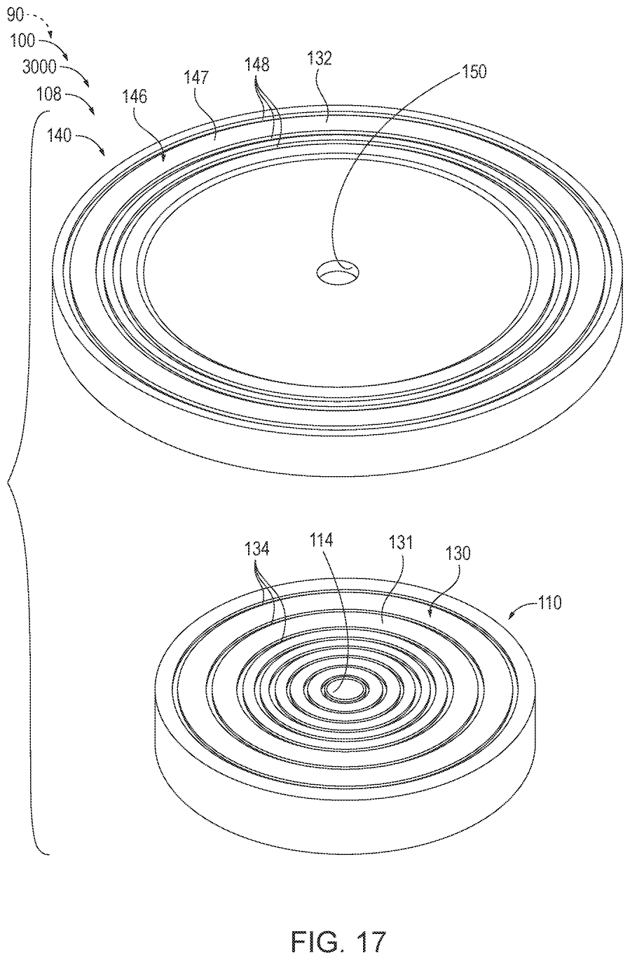

FIGS. 1-4 are schematic illustrations of examples of a valve testing machine 50 configured to test a valve 10 (shown in FIGS. 1-3) utilizing a valve seal assembly 100 according to the present disclosure, while FIGS. 5-19 provide less schematic illustrations of examples of valve seal assemblies and/or of valve testing machines utilizing the valve seal assemblies. In particular, FIGS. 5-11 illustrate a first example seal assembly 1000, which is an example of valve seal assembly 100 according to the present disclosure. FIGS. 12-16 illustrate a second example valve seal assembly 2000, which is another example of valve seal assembly 100 according to the present disclosure, with FIGS. 12-14 illustrating the second example seal assembly 2000 in combination with valve testing machine 50. FIGS. 17-19 illustrate a third example seal assembly 3000, which is another example of valve seal assembly 100 according to the present disclosure. In the present disclosure, valve testing machine 50 may be described as including valve seal assembly 100, and/or valve seal assembly 100 may be described as an accessory for use with valve testing machine 50.

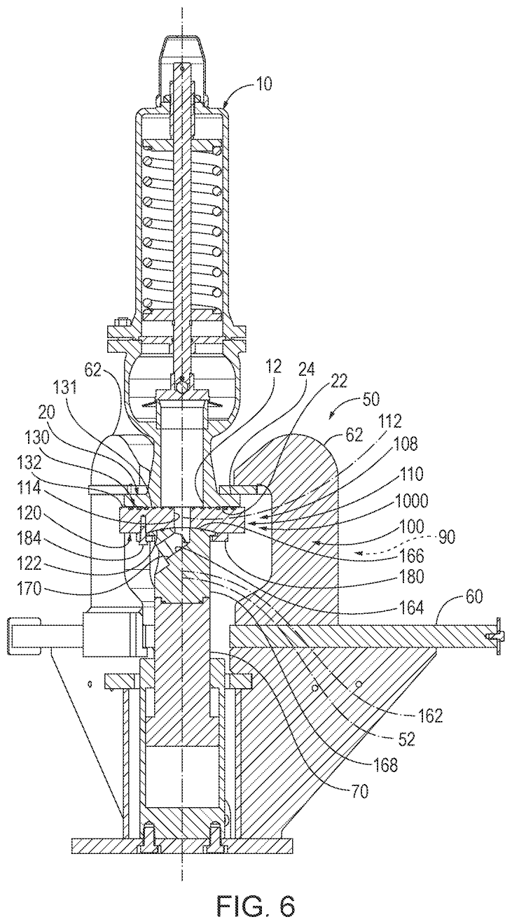

As schematically illustrated in FIG. 1 and less schematically illustrated in FIGS. 5-6, the present disclosure generally relates to valve seal assemblies 100 for operatively coupling a valve 10 to a valve testing machine 50. In particular, the present disclosure generally relates to examples in which valve 10 is a pressure relief valve and/or a safety relief valve. For example, and as schematically illustrated in FIG. 1 and less schematically illustrated in FIG. 5, valve 10 may include a valve inlet 12 (shown in FIG. 1) that is configured to receive a pressurized fluid and a pressure relief outlet 14 that is configured to release at least a portion of the pressurized fluid when a pressure of the pressurized fluid exceeds a threshold operative fluid pressure. In this manner, valve 10 may be configured to be utilized in conjunction with a pressurized fluid system to prevent failure, damage, and/or injury in the event that a system pressure exceeds the threshold operative fluid pressure.

In view of the important role that such valves perform in ensuring workplace safety, it often is desirable to evaluate the performance of such valves periodically to ensure that the valves function according to specification. Accordingly, valve testing machines 50 according to the present disclosure generally are configured to convey a pressurized fluid to valve inlet 12 at a controlled pressure and to test the performance of the valve to expel the pressurized fluid from pressure relief outlet 14 in an appropriate manner. Examples of pressurized fluids that may be utilized by valve testing machines 50 (e.g., during operative use in a pressurized fluid system and/or during testing by valve testing machine 50) include a liquid, water, a gas, air, and/or nitrogen.

In some examples, and as schematically illustrated in FIGS. 1-3 and less schematically illustrated in FIGS. 5-7, valve 10 includes a sealing flange 20 to facilitate operatively coupling the valve to a pressurized fluid system. In some examples, sealing flange 20 is configured to receive, to engage, and/or to be utilized in conjunction with a plurality of mechanical fasteners, such as bolts, to install the valve on the pressurized fluid system in a fluid-tight and semi-permanent manner. However, the process of coupling sealing flange 20 to the pressurized fluid system with such bolts may be time- and/or labor-intensive. Thus, in order to facilitate efficient testing of valve 10 by valve testing machine 50, it may be desirable to fluidly couple the valve to the valve testing machine or to an associated component without the use of such mechanical fasteners. Accordingly, the present disclosure relates to examples in which valve testing machine 50 forms a fluid-tight connection with valve 10 at least partially by exerting a clamping force upon sealing flange 20 to urge valve seal assembly 100 into fluid-tight contact with valve 10.

In some examples, and as schematically illustrated in FIG. 1 and less schematically illustrated in FIGS. 5-6, valve testing machine 50 includes a machine base 60 and a plurality of clamp arms 62 operatively coupled to the machine base and configured to engage sealing flange 20 of valve 10. As additionally shown in FIGS. 1 and 5-6, valve testing machine 50 further includes a force exerting mechanism 70 configured to translate along a testing machine central axis 52 (shown in FIGS. 1 and 6) to apply a sealing force to valve 10. More specifically, and as schematically illustrated in FIGS. 1-3 and less schematically illustrated in FIG. 6, sealing flange 20 may include a first flange surface 22 and a second flange surface 24 opposite the first flange surface, such that the first flange surface is configured to engage valve seal assembly 100 and such that the second flange surface is configured to engage each clamp arm 62. Accordingly, during operative use of the valve testing machine, and as shown in FIGS. 1 and 6, force exerting mechanism 70 applies the sealing force to first flange surface 22 of sealing flange 20 via valve seal assembly 100 while each clamp arm 62 engages second flange surface 24 of sealing flange 20, thus urging valve 10 and valve seal assembly 100 into a secure and fluid-tight connection.

Force exerting mechanism 70 may include and/or be any of a variety of mechanisms, devices, machines, etc. that are configured to apply the sealing force to valve 10 via valve seal assembly 100. As an example, and as schematically illustrated in FIG. 1 and less schematically illustrated in FIGS. 5-9 and 12-14, force exerting mechanism 70 may include and/or be a hydraulic ram. As additional examples, force exerting mechanism 70 may include and/or be a mechanical force exerting mechanism, a screw mechanism, an ACME screw, a lead screw, a cam mechanism, etc.

As used herein, valve testing machine 50 and/or valve seal assembly 100 may be described as being “in operative use” and/or as being “operatively utilized” when valve seal assembly 100 engages valve 10 and/or sealing flange 20 thereof to form a fluid-tight connection such that the valve testing machine is operative to supply the pressurized fluid to the valve via the valve seal assembly. In this manner, references within the present disclosure to valve testing machine 50, valve seal assembly 100, and/or various components thereof in conjunction with valve 10 and/or sealing flange 20 are intended to refer to a configuration in which valve testing machine 50 and/or valve seal assembly 100 operatively engage valve 10 as described herein. However, while the present disclosure generally describes examples in which valve testing machine 50 and/or valve seal assembly 100 operatively engage valve 10, such examples are not intended to be limiting, and it is within the scope of the present disclosure that valve testing machine 50 and/or valve seal assembly 100 are not always operatively coupled to and/or actively utilized in conjunction with valve 10. Additionally, as used herein, a state in which valve testing machine 50 is in operative use also may be referred to as a state in which valve seal assembly 100 is in operative use, and vice-versa.

In various examples, valve testing machine 50 is configured such that the configurations and/or positions of clamp arms 62 may be selectively adjusted, such as to accommodate any of a variety of valves 10 and/or sealing flanges 20 thereof. In particular, in some examples, each clamp arm is configured to be selectively translated relative to machine base 60, such as along a direction perpendicular to testing machine central axis 52, but is restricted from translating relative to machine base 60 along a direction parallel to testing machine central axis 52.

In some prior art examples of valve testing machines (e.g., valve testing machines that do not utilize valve seal assemblies 100 according to the present disclosure), a force exerting mechanism (e.g., a component functionally equivalent to force exerting mechanism 70) urges sealing flange 20 of valve 10 into a fluid-tight connection with a seal plate through which the pressurized fluid is provided to valve inlet 12. In such examples, the dimensions (e.g., the inner diameter and/or the outer diameter) of the seal plate effectively impose constraints on the dimensions of valves 10 that may be tested while in fluid-tight engagement with the seal plate. Accordingly, in some such prior art valve testing machines, the seal plate is selected from among a plurality of available seal plates to match and/or otherwise correspond to a diameter of sealing flange 20 of valve 10 to be engaged by the valve testing machine. Moreover, in some such valve testing machines, a plane defined by the seal plate surface facing sealing flange 20 and a plane of contact defined by clamp arms of the valve testing machine (e.g., components functionally equivalent to clamp arms 62) are perfectly, or nearly perfectly, parallel to one another. Accordingly, such a configuration may necessitate that first flange surface 22 and second flange surface 24 of sealing flange 20 be similarly perfectly (or nearly perfectly) parallel to one another in order to maintain a secure and fluid-tight connection between the sealing flange and the seal plate. As described in more detail herein, valve seal assemblies 100 according to the present disclosure alleviate these and other issues associated with prior art valve testing machines.

As schematically illustrated in FIG. 1, valve seal assembly 100 is configured to operatively fluidly couple valve 10 to valve testing machine 50, as described herein. In particular, and schematically illustrated in FIGS. 1-3, valve seal assembly 100 includes a seal plate structure 108 with a valve seal surface 132 that is configured to engage sealing flange 20 of valve 10 to form a fluid-tight seal with the sealing flange. Valve seal assembly 100 additionally includes a force transfer member 160 with a force transfer member body 168 that is configured to be operatively coupled to force exerting mechanism 70 of valve testing machine 50 (as shown at least in FIG. 1). In particular, force transfer member body 168 is configured to be interposed between force exerting mechanism 70 and seal plate structure 108 such that, when the force exerting mechanism is actuated to exert the sealing force, the force transfer member body conveys at least a portion of the sealing force to the seal plate structure. In this manner, force transfer member 160 is configured such that force transfer member 160 urges seal plate structure 108 into contact with sealing flange 20 under the sealing force applied by force exerting mechanism 70.

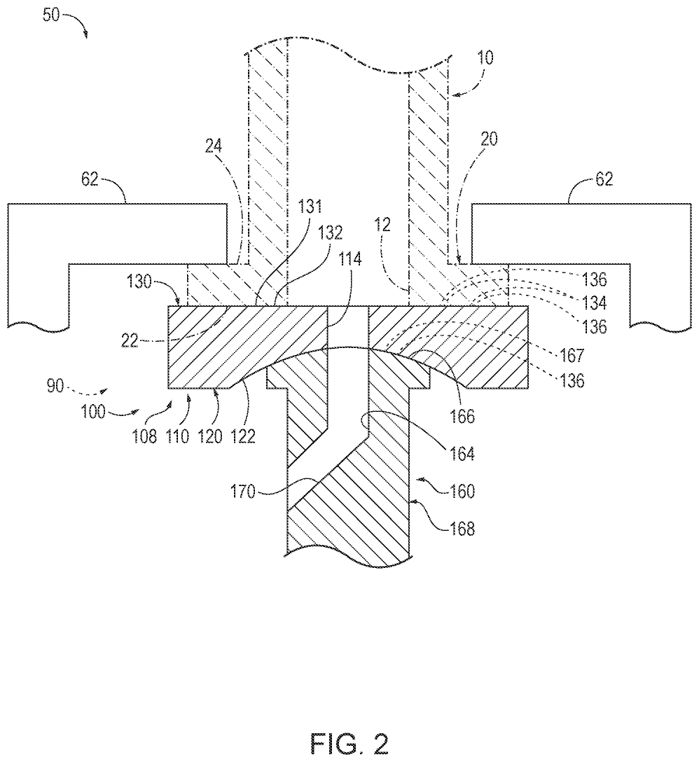

Valve seal assembly 100 generally is configured to supply the pressurized fluid to valve 10 via seal plate structure 108. In particular, in some examples, and as schematically illustrated in FIGS. 1-3, force transfer member body 168 defines a fluid inlet 170 for receiving a flow of the pressurized fluid, and force transfer member 160 defines a force transfer member fluid channel 164 for conveying the pressurized fluid through the force transfer member. In such examples, seal plate structure 108 defines a seal plate fluid channel 114 extending through at least a portion of the seal plate structure. In such examples, and as shown at least in FIG. 2, valve seal assembly 100 is configured such that force transfer member fluid channel 164 is at least partially aligned with seal plate fluid channel 114 during operative use of valve testing machine 50 to permit the pressurized fluid to flow from fluid inlet 170 to valve inlet 12 via force transfer member fluid channel 164 and seal plate fluid channel 114. As used herein, the term “at least partially aligned,” as used to describe a relative configuration of two channels, apertures, holes, etc. is intended to refer to any configuration in which the two channels, apertures, holes, etc. are fluidly connected and/or coupled to one another to permit a fluid to flow from one to the other.

Seal plate structure 108 may include any of a variety of components, or sets of components, for forming a fluid-tight seal against sealing flange 20 of valve 10 and/or for conveying the pressurized fluid flow from force transfer member 160 to valve inlet 12 in a fluid-tight manner. In particular, in various examples, and as described in more detail herein, seal plate structure 108 includes one or more components that may be selectively utilized in order to adapt valve seal assembly 100 for operative use with valve 10 of any of a variety of dimensions.

In some examples, and as schematically illustrated in FIGS. 1-4, seal plate structure 108 includes a base seal plate 110 with a base seal plate first surface 120 and a base seal plate second surface 130 opposite the base seal plate first surface. As schematically illustrated in FIGS. 1-4, base seal plate first surface 120 may be configured to face toward and/or engage force transfer member 160 during operative use of valve testing machine 50. As additionally schematically illustrated in FIGS. 1-3, base seal plate second surface 130 includes a base seal plate sealing interface 131 that is configured to form a fluid-tight seal with a component that engages base seal plate 110. In particular, in some examples, base seal plate sealing interface 131 is configured to form a fluid-tight seal with valve 10 and/or sealing flange 20. In such examples, base seal plate second surface 130 and/or base seal plate sealing interface 131 may be described as including, or as being, valve seal surface 132.

In some examples, and as schematically illustrated in FIG. 2 and less schematically illustrated in FIGS. 5-7, base seal plate 110 includes valve seal surface 132, such that base seal plate 110 directly engages sealing flange 20 during operative use of valve testing machine 50 to test valve 10. In such examples, and as described in more detail below, base seal plate 110 may include any of a variety of features for forming a fluid-tight seal with sealing flanges 20 of any of a variety of dimensions (e.g., diameters). However, in some examples, base seal plate 110 may not be appropriately sized to form a suitable fluid-tight seal against a given sealing flange 20. For example, it may be desirable to utilize valve seal assembly 100 to form a fluid-tight seal with a particular valve 10 with a respective valve inlet 12 that has an inner diameter that is comparable to, or larger than, an outer diameter of base seal plate 110. As another example, it may be desirable to utilize valve seal assembly 100 to form a fluid-tight seal with a particular valve 10 with a respective sealing flange 20 that has an outer diameter that is comparable to, or smaller than, an inner diameter of seal plate fluid channel 114 within base seal plate 110. In such examples, base seal plate 110 may be utilized in combination with one or more other elements of seal plate structure 108 to adapt the seal plate structure to the dimensions of valve 10 to be tested without necessitating replacement of base seal plate 110.

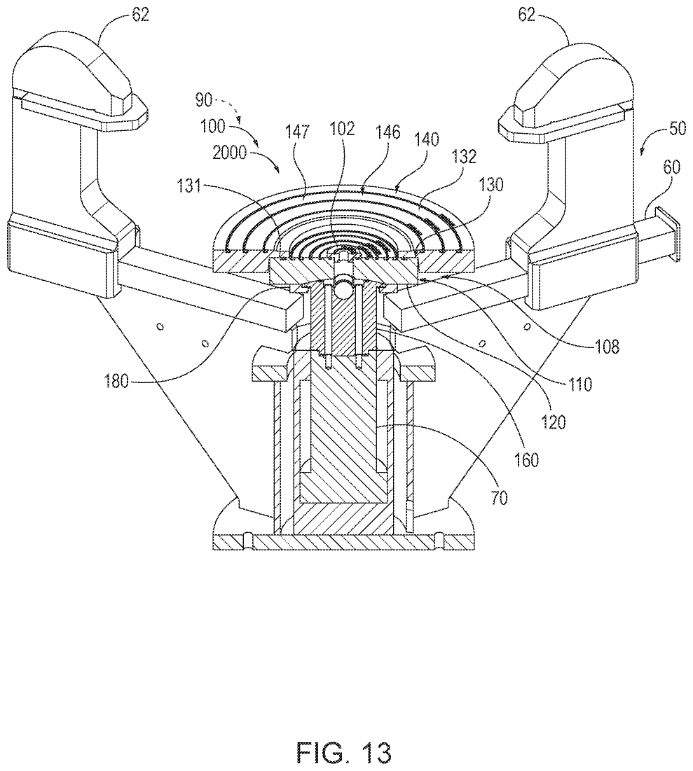

More specifically, in some examples, and as schematically illustrated in FIG. 1 and less schematically illustrated in FIGS. 13-16, seal plate structure 108 includes at least one expansion adapter seal plate 140 that is configured to be interposed between base seal plate 110 and valve 10 during operative use of valve seal assembly 100. Specifically, in such examples, expansion adapter seal plate 140 may have an outer diameter that is greater than that of base seal plate 110. For example, in an example in which valve seal assembly 100 is to be used to test a valve 10 with a sealing flange 20 that has a diameter that is too large to form an operative seal with base seal plate 110, expansion adapter seal plate 140 may be interposed between base seal plate 110 and sealing flange 20 such that the expansion adapter seal plate 140 sealingly engages base seal plate 110. Stated differently, in such examples, expansion adapter seal plate 140 includes valve seal surface 132. Thus, in such examples, expansion adapter seal plate 140 may be utilized to form a fluid-tight connection with a sealing flange 20 that is too large to form a fluid-tight connection to base seal plate 110 directly.

As used herein, the term “diameter,” as used to characterize a linear dimension of a component of valve seal assembly 100 and/or of valve 10, generally refers to a dimension as measured perpendicular to a central axis characterizing the component. As an example, an inner diameter and/or an outer diameter of sealing flange 20 of valve 10 generally refers to a dimension as measured perpendicular to testing machine central axis 52 during operative use of valve testing machine 50. Similarly, and as schematically illustrated in FIG. 1, seal plate structure 108 may be described as defining a seal plate central axis 112 that is perpendicular to valve seal surface 132. Accordingly, an inner diameter and/or an outer diameter of a component of seal plate structure 108 (e.g., of base seal plate 110 and/or of expansion adapter seal plate 140) generally refers to a dimension as measured perpendicular to seal plate central axis 112.

In some examples, and as illustrated in FIGS. 17-19, base seal plate 110 may be utilized in conjunction with a single expansion adapter seal plate 140 during operative use of valve seal assembly 100. Stated differently, in such examples, the expansion adapter seal plate is configured to directly engage each of base seal plate 110 and sealing flange 20. However, in some examples, a single and/or a particular expansion adapter seal plate 140 may be improperly sized to provide valve seal surface 132 with a sufficient diameter to sealingly engage sealing flange 20 of a particular valve 10. Accordingly, in some examples, and as schematically illustrated in FIG. 1, seal plate structure 108 may include a plurality of expansion adapter seal plates 140 that are configured to engage one another, such as in a sequence of progressively increasing outer diameter. Thus, in various examples, preparing valve seal assembly 100 and/or valve testing machine 50 for operative use to test a particular valve 10 may include selecting an expansion adapter seal plate 140, or a plurality of expansion adapter seal plates, with dimensions that collectively are suitable for forming a fluid-tight fluid conduit between base seal plate 110 and valve inlet 12. While FIG. 1 schematically illustrates an example in which base seal plate 110 is utilized in conjunction with two expansion adapter seal plates 140, it is within the scope of the present disclosure that any suitable number of expansion adapter seal plates may be utilized to form the fluid-tight fluid conduit between base seal plate 110 and valve inlet 12.

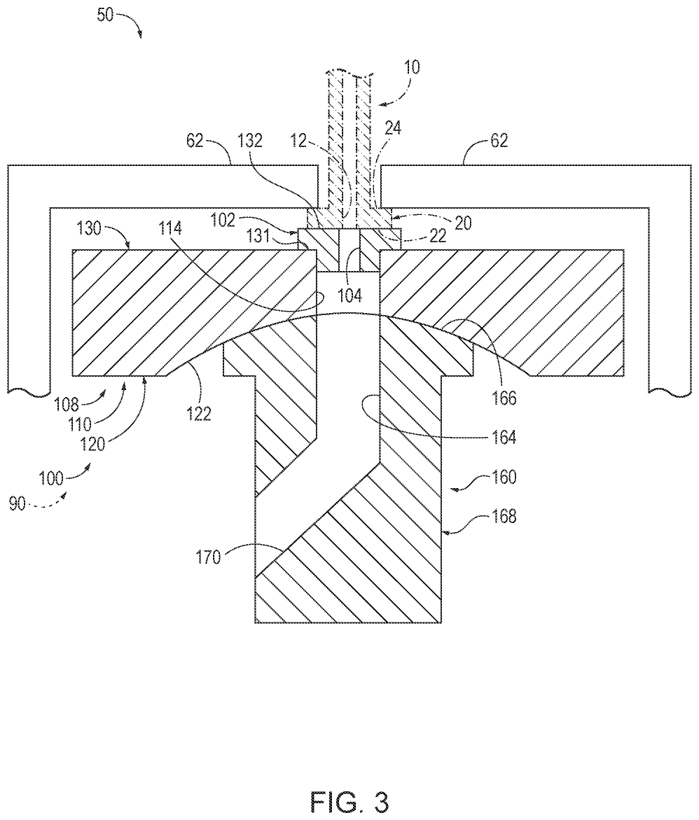

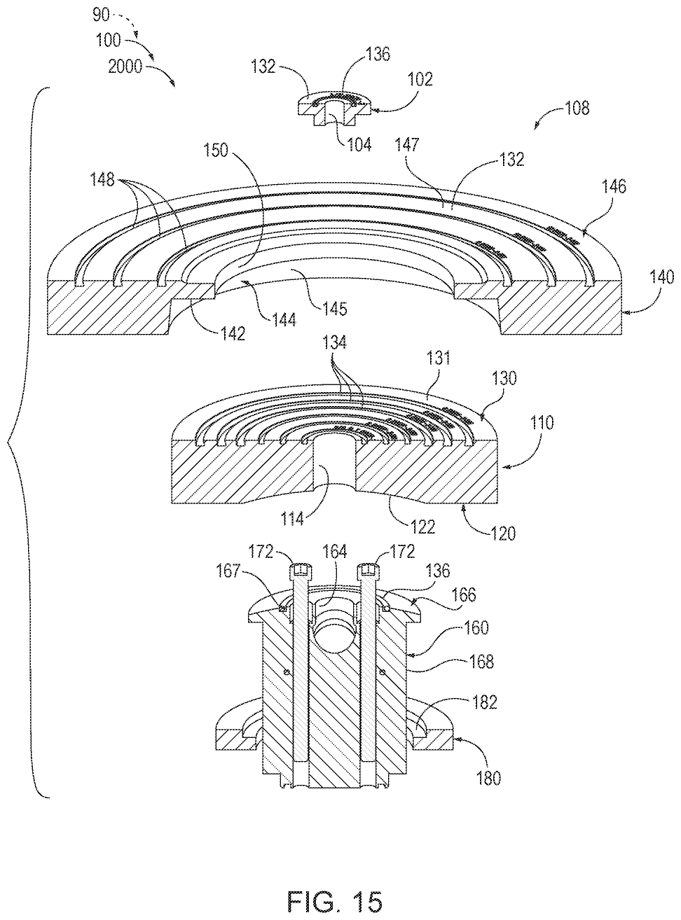

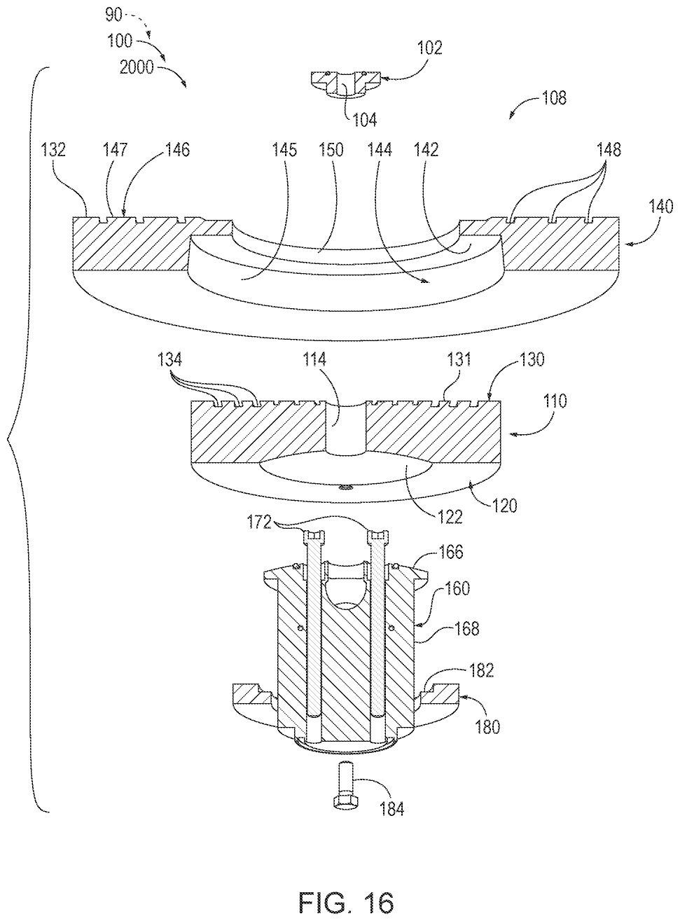

Additionally or alternatively, in some examples, and as schematically illustrated in FIGS. 1 and 3 and less schematically illustrated in FIGS. 12-16, seal plate structure 108 includes a reduction adapter seal plate 102 that is configured to be at least partially received within base seal plate 110 and/or seal plate fluid channel 114 during operative use of valve seal assembly 100. When present, and as perhaps best illustrated in FIG. 3, reduction adapter seal plate 102 may enable valve seal assembly 100 to be utilized to test a valve 10 with a sealing flange 20 and/or a valve inlet 12 that is too small (e.g., in inner diameter and/or outer diameter) to form a suitable fluid-tight seal directly with base seal plate 110. In such examples, and as schematically illustrated in FIG. 3, reduction adapter seal plate 102 includes at least a portion of valve seal surface 132. In some examples, and as schematically illustrated in FIGS. 1 and 3 and less schematically illustrated in FIGS. 15-16, reduction adapter seal plate 102 defines a reduction adapter seal plate fluid channel 104 that is aligned with and/or fluidly connected to seal plate fluid channel during operative use of valve testing machine 50. Accordingly, in such examples, valve seal assembly 100 may be configured such that the pressurized fluid flows to valve 10 via reduction adapter seal plate fluid channel 104 during operative use of valve testing machine 50.

While FIGS. 1 and 12-16 illustrate examples of valve seal assembly 100 that include expansion adapter seal plate(s) 140 as well as reduction adapter seal plate 102, these components may not be (and typically are not) utilized in combination with one another during operative use of valve testing machine 50. Instead, FIGS. 1 and 12-16 illustrate expansion adapter seal plate(s) 140 and reduction adapter seal plate 102 as examples of components of seal plate structure 108 that may be selectively utilized based upon dimensions and/or characteristics of the valve to be tested. For example, second example seal assembly 2000 of FIGS. 12-16 may be configured such that, during operative use of valve testing machine 50, seal plate structure 108 includes base seal plate 110 alone, includes base seal plate 110 in combination with expansion adapter seal plate 140, or includes base seal plate 110 in combination with reduction adapter seal plate 102, depending upon the dimensions of valve 10, of sealing flange 20, and/or of valve inlet 12.

In addition to accommodating valves 10 and/or sealing flanges 20 of any of a variety of dimensions, valve seal assembly 100 also may be configured to accommodate variances in the shape and/or dimensions of the sealing flange itself. For example, force transfer member 160 may be configured to engage seal plate structure 108 such that an orientation (e.g., a rotational orientation) of seal plate structure 108 relative to force transfer member 160 may be selectively and/or automatically adjusted (e.g., prior to operative use of valve testing machine 50 to test valve 10). In particular, and as schematically illustrated in FIGS. 1-4, seal plate structure 108 may include a socket receiver 122 opposite valve seal surface 132, and force transfer member 160 may include a socket head 166 extending from force transfer member body 168 such that the socket head is received within the socket receiver during operative use of valve testing machine 50. In some examples, base seal plate first surface 120 includes socket receiver 122. In this manner, during operative use of valve testing machine 50, the sealing force is conveyed from force transfer member 160 to seal plate structure 108 via the interface of socket receiver 122 and socket head 166. In some such examples, and as schematically illustrated in FIGS. 1-4, force transfer member fluid channel 164 extends between fluid inlet 170 and socket head 166, and seal plate fluid channel 114 extends at least partially between socket receiver 122 and valve seal surface 132.

While the present disclosure generally relates to examples in which seal plate structure 108 includes socket receiver 122 and force transfer member 160 includes socket head 166, this is not required of all examples of valve testing machine 50 and/or of valve seal assembly 100. For example, it also is within the scope of the present disclosure that seal plate structure 108 may include socket head 166 and that force transfer member 160 may include socket receiver 122.

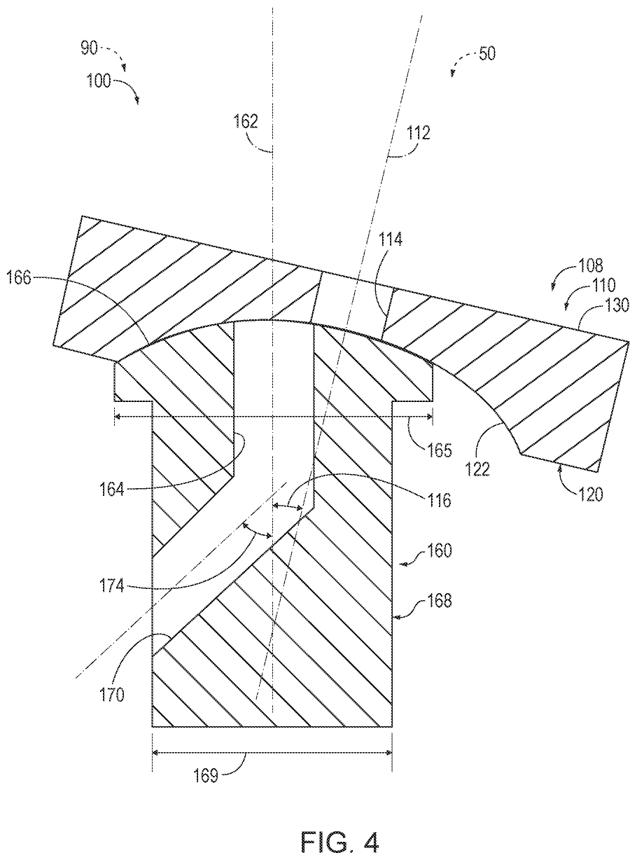

In some examples, and as illustrated at least in FIG. 4, socket head 166 is a convex socket head 166, and socket receiver 122 is a concave socket receiver 122 that is configured to receive socket head 166 in any of a plurality of distinct orientations (such as rotational and/or angular orientations). Stated differently, in such examples, socket head 166 and socket receiver 122 may include respective mating surfaces that are configured to stably engage one another when the socket receiver is in any of a plurality of rotational orientations relative to the socket head. In this manner, in such examples, valve seal assembly 100 may be configured such that seal plate structure 108 may engage force transfer member 160 in a fluid-tight seal even when the seal plate structure is angled and/or tilted relative to the force transfer member (and/or relative to testing machine central axis 52).

In particular, in some examples, valve seal assembly 100 is configured such that force transfer member fluid channel 164 and seal plate fluid channel 114 remain fluidly coupled to one another when seal plate structure 108 is in any of a variety of rotational and/or angular orientations relative to force transfer member 160. For example, and as illustrated at least in FIG. 4, force transfer member 160 may be described as extending along and defining a force transfer member central axis 162, which may be angled relative to seal plate central axis 112 during operative use of valve testing machine 50. Valve seal assembly 100 thus may be described as being configured such that force transfer member fluid channel 164 and seal plate fluid channel 114 are fluidly connected (or, equivalently, such that the force transfer member fluid channel and the seal plate fluid channel are at least partially aligned) when seal plate central axis 112 and force transfer member central axis 162 are sufficiently aligned. More specifically, and as schematically illustrated in FIG. 4, valve seal assembly 100 may be configured such that force transfer member fluid channel 164 and seal plate fluid channel 114 are fluidly connected when socket head 166 is operatively received within socket receiver 122 and when seal plate central axis 112 is either collinear with force transfer member central axis 162 or is angled relative to the force transfer member central axis by at most a threshold offset angle 116. For clarity, the threshold offset angle is exaggerated in the schematic illustration of FIG. 4.

Valve seal assembly 100 may be configured such that threshold offset angle 116 assumes any of a variety of values. As examples, the threshold offset angle may be at least 1 degree, at least 3 degrees, at least 5 degrees, at most 10 degrees, at most 7 degrees, and/or at most 2 degrees. Such configurations may facilitate forming a fluid-tight seal between sealing flange 20 and seal plate structure 108 even when first flange surface 22 and second flange surface 24 are not perfectly parallel to one another. In particular, in some examples, sealing flange 20 may vary slightly in thickness across an area of the sealing flange, such that first flange surface 22 and second flange surface 24 are not fully parallel to one another. Accordingly, when testing valve 10 with such a sealing flange, the rotational adjustability of seal plate structure 108 relative to force transfer member 160 may enable the seal plate structure to form a fluid-tight seal against the first flange surface in a plane that is angled relative to a plane in which each clamp arm 62 engages the second flange surface.

In some examples, socket head 166 and/or socket receiver 122 are at least substantially spherical in shape, such as to ensure that socket head 166 remains in sealing engagement with socket receiver 122 when seal plate structure 108 is in any of a variety of rotational and/or angular orientations relative to force transfer member 160. As used herein, a component (such as socket head 166 and/or socket receiver 122) may be described as being spherical, or at least substantially spherical, in shape when at least a portion of the component forms at least a portion of a sphere. Accordingly, such descriptions do not require that the component form a full sphere, but instead are intended to characterize a manner in which the component is curved.

Utilizing expansion adapter seal plate 140 in combination with base seal plate 110 during operative use of valve testing machine 50 may offer any of a variety of functional benefits over utilizing expansion adapter seal plate 140 without base seal plate 110 (e.g., by configuring the expansion adapter seal plate to directly engage each of sealing flange 20 and force transfer member 160). For example, utilizing a seal plate (such as base seal plate 110 or expansion adapter seal plate 140) with an outer diameter that is large relative to a diameter of the interface between seal plate structure 108 and force transfer member 160 (e.g., the diameter of socket receiver 122) may result in a correspondingly large torque and/or bending moment being applied across the seal plate. In particular, such a torque and/or bending moment may arise from the center of the seal plate being urged upward by force transfer member 160 while an outer perimeter of the seal plate is restricted from translating upward by sealing flange 20 (e.g., due to engagement with the fixed clamp arms 62). By contrast, configuring seal plate structure 108 such that base seal plate 110 engages force transfer member 160 and such that expansion adapter seal plate 140 is interposed between base seal plate 110 and sealing flange 20 may operate to enhance a rigidity of seal plate structure 108, thereby mitigating any adverse effects associated with such a bending moment. Additionally, such a configuration provides a degree of modularity in accommodating valves 10 of various sizes, such as by enabling a user to select one or more expansion adapter seal plates 140 that correspond in size with the specific valve 10 under test.

In some examples, valve seal assembly 100 is configured such that seal plate structure 108 and force transfer member 160 are not fixedly coupled to one another. Stated differently, in such examples, valve seal assembly 100 may be configured such that seal plate structure 108 and force transfer member 160 remain in a static orientation relative to one another during operative use of valve testing machine 50, but such that the seal plate structure is free to move relative to the force transfer member when valve 10 is removed from the valve testing machine. For example, valve seal assembly 100 may lack structures and/or fasteners for fixedly coupling seal plate structure 108 and force transfer member 160 to one another, such that an orientation of seal plate structure 108 relative to force transfer member 160 is fixed only upon applying the sealing force with force exerting mechanism 70.

Accordingly, in some such examples, and as schematically illustrated in FIG. 1 and less schematically illustrated in FIGS. 6-16, valve seal assembly 100 includes a retaining ring 180 that is configured to restrict seal plate structure 108 from being fully removed from force transfer member 160. In such examples, and as schematically illustrated in FIG. 1 and less schematically illustrated at least in FIGS. 6, 9, and 16, retaining ring 180 is configured to be selectively and operatively coupled to seal plate structure 108, such as via one or more retaining ring mechanical fasteners 184 (e.g., bolts).

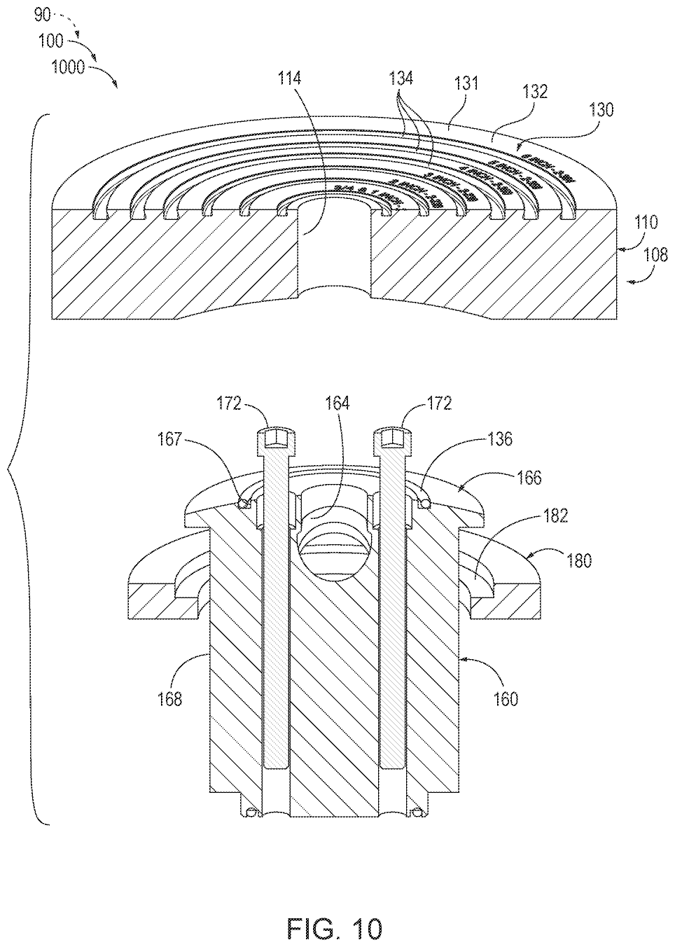

When present, and when fixedly coupled to seal plate structure 108, retaining ring 180 (and thus seal plate structure 108) may be mechanically restricted from being removed from force transfer member 160 due to one or more geometrical features of the force transfer member. For example, and as schematically illustrated in FIG. 4, force transfer member body 168 may have a force transfer member body diameter 169, and socket head 166 may have a socket head diameter 165 (e.g., as measured along a direction perpendicular to force transfer member central axis 162) that is greater than the force transfer member body diameter. In such examples, the socket head may be described as including a lip and/or an overhang that extends beyond the outermost radial extent of the force transfer member body. In some such examples, and as schematically illustrated in FIG. 1 and less schematically illustrated in FIGS. 10-11 and 15-16, retaining ring 180 defines a retaining ring recess 182 that is configured to receive a portion of socket head 166 while retaining ring 180 is operatively coupled to seal plate structure 108. In particular, such a configuration may allow for movement (e.g., shifting and/or rotating) of seal plate structure 108 relative to force transfer member 160 while restricting the seal plate structure from being entirely removed from and/or inadvertently falling off of the force transfer member.

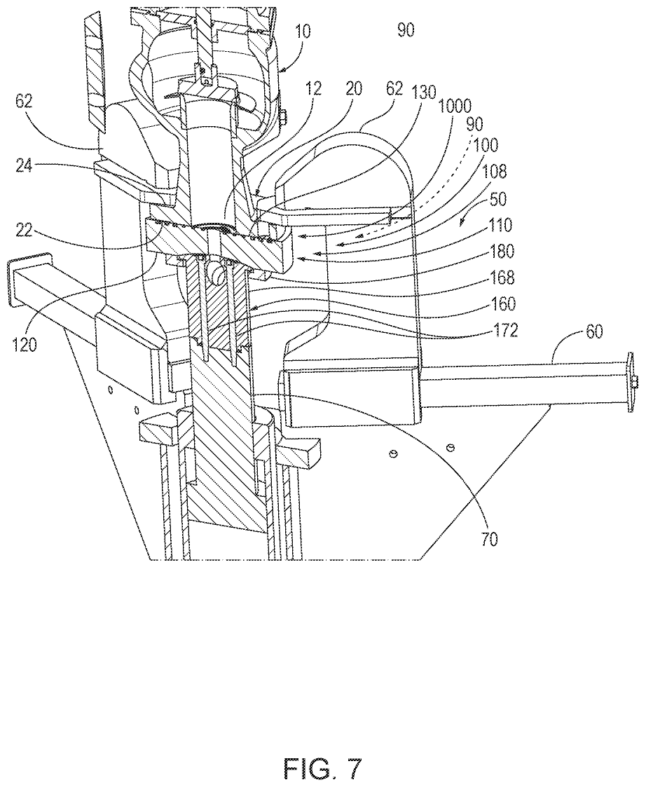

In some examples, such as in the examples of FIGS. 5-16, force transfer member body 168 is at least substantially cylindrical. However, this is not required of all examples of force transfer member 160, and it is additionally within the scope of the present disclosure that force transfer member body 168 may have any of a variety of forms, configurations, and/or shapes (e.g., cross-sectional shapes). In some examples, force transfer member 160 is configured to be fixedly, permanently, and/or semi-permanently coupled to force exerting mechanism 70. For example, and as illustrated at least in FIGS. 7-8, 10-11, and 15-16, valve seal assembly 100 may include one or more force transfer member mechanical fasteners 172 (e.g., bolts) configured to fixedly couple force transfer member 160 to force exerting mechanism 70. Additionally or alternatively, in some examples, force exerting mechanism 70 may include at least a portion of force transfer member 160 and/or a portion of force transfer member body 168.

Fluid inlet 170 may be configured to receive and/or direct the pressurized fluid in any of a variety of manners during operative use of valve testing machine 50. In some examples, fluid inlet 170 is configured to receive a fluid flow of the pressurized fluid along a direction that is oblique to force transfer member central axis 162. For example, and as schematically illustrated in FIGS. 1-4, at least a portion of force transfer member fluid channel 164 may be oriented along a direction that is oblique to force transfer member central axis 162 (shown in FIGS. 1 and 4). Such a configuration may enhance the flow dynamics of the pressurized fluid through force transfer member fluid channel 164 during operative use of valve testing machine 50, such as relative to a configuration in which the force transfer member fluid channel receives and/or directs the pressurized fluid along a direction perpendicular to the force transfer member central axis. In particular, because force transfer member fluid channel 164 directs the pressurized fluid out of socket head 166 along a direction at least substantially parallel to force transfer member central axis 162, configuring fluid inlet 170 to receive the pressurized fluid along a direction oblique to force transfer member central axis 162 may reduce a pressure drop of the pressurized fluid within force transfer member 160 relative to a configuration in which force transfer member fluid channel 164 includes a more abrupt (e.g., 90-degree) bend within force transfer member 160.

As schematically illustrated in FIG. 4, force transfer member fluid channel 164 may be characterized by an inlet angle 174, which represents an angle between force transfer member central axis 162 and a direction along which the force transfer member fluid channel receives the pressurized fluid. As a more specific example, and as schematically illustrated in FIGS. 1-4 and less schematically illustrated at least in FIGS. 6, 9, and 14, inlet angle 174 (labeled in FIG. 4) may be about 45 degrees. However, this is not required of all examples of force transfer member 160, and it is additionally within the scope of the present disclosure that the inlet angle may be any of a variety of angles, examples of which include at least 10 degrees, at least 20 degrees, at least 30 degrees, at least 40 degrees, at least 50 degrees, at least 60 degrees, at least 70 degrees, at most 75 degrees, at most 65 degrees, at most 55 degrees, at most 45 degrees, at most 35 degrees, at most 25 degrees, and/or at most 15 degrees.

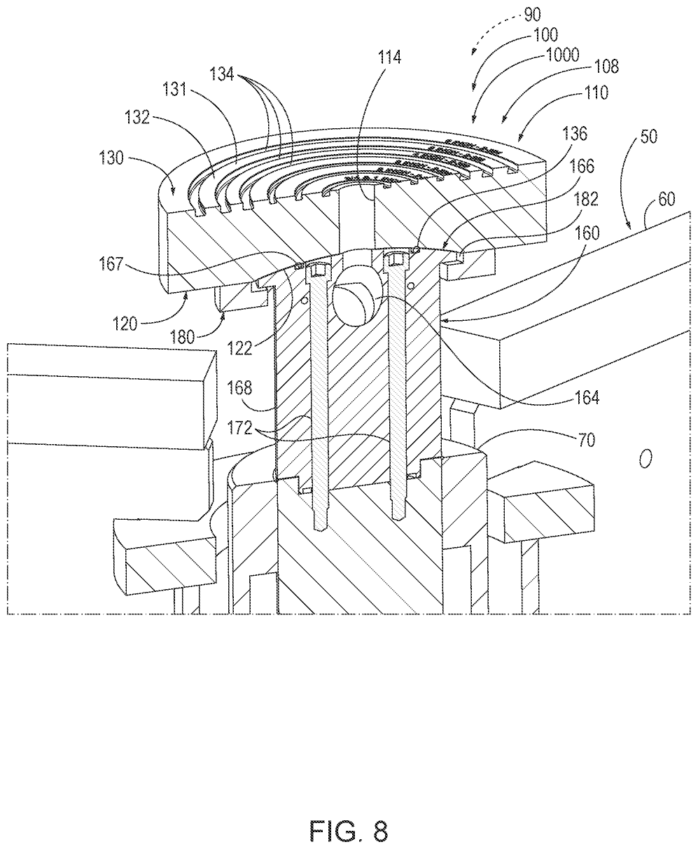

In various examples, valve seal assembly 100 additionally includes one or more components for forming and/or enhancing a fluid-tight seal between various components disclosed herein. For example, and as schematically illustrated in FIG. 2 and less schematically illustrated at least in FIGS. 8-11 and 15-16, base seal plate sealing interface 131 may include a plurality of base seal plate sealing component channels 134, and valve seal assembly 100 may include one or more sealing components 136 (illustrated in FIG. 15), each received within a corresponding base seal plate sealing component channel. Specifically, in such examples, each base seal plate sealing component channel 134 is configured to receive a corresponding sealing component 136 for forming a fluid-tight seal, such as with valve 10, with sealing flange 20, and/or with another component of seal plate structure 108.

As discussed, in some examples, such as in the example of FIGS. 5-11, valve seal assembly 100 is configured such that base seal plate 110 directly engages sealing flange 20 (shown in FIGS. 5-7), such that base seal plate sealing interface 131 includes and/or is valve seal surface 132. In some such examples, the plurality of base seal plate sealing component channels 134 of varying diameters may enable base seal plate 110 to form a fluid-tight seal with valves 10 with sealing flanges 20 with any of a corresponding variety of diameters.

As discussed in more detail herein, one or more sealing components 136 of valve seal assembly 100 additionally or alternatively may be utilized to form a fluid-tight seal with and/or between other components of valve seal assembly 100 and/or of valve 10. As examples, sealing component 136 (e.g., a particular sealing component of valve seal assembly 100) may be utilized to form a fluid-tight seal between any two of base seal plate 110, expansion adapter seal plate 140 (e.g., a first expansion adapter seal plate), another expansion adapter seal plate 140 (e.g., a second expansion adapter seal plate that forms a fluid-tight seal against the first expansion adapter seal plate), reduction adapter seal plate 102, force transfer member 160, valve 10, and/or sealing flange 20. As a more specific example, and as illustrated at least in FIG. 15, reduction adapter seal plate 102 may be configured to receive a corresponding sealing component 136.

Each sealing component 136 may include and/or be any of a variety of components for forming, maintaining, and/or enhancing a fluid-tight seal between the components between which the sealing component is interposed. As an example, and as illustrated at least in FIGS. 10-11 and 15-16, each sealing component 136 may be an O-ring. However, this is not required of all examples of valve seal assembly 100, and it is additionally within the scope of the present disclosure that sealing component 136 may be any of a variety of other components for forming a fluid-tight seal, examples of which include a sealing gasket, a ring type joint, and a sealing surface.

In some examples, each base seal plate sealing component channel 134 is at least substantially circular, and the plurality of base seal plate sealing component channels are at least substantially concentric with one another. In such examples, each base seal plate sealing component channel 134 may have a distinct respective diameter, such as to enable base seal plate sealing interface 131 to form a fluid-tight seal with components of any of a corresponding variety of diameters.

Similarly, in some examples, and as schematically illustrated in FIG. 2 and less schematically illustrated at least in FIGS. 10-11 and 15, socket head 166 includes a socket head sealing component channel 167 that is configured to receive a corresponding sealing component 136 for forming a fluid-tight seal against socket receiver 122. While the present disclosure generally is directed to examples in which socket head 166 includes socket head sealing component channel 167, this is not required of all examples of valve seal assembly 100. For example, it also is within the scope of the present disclosure that socket receiver 122 additionally or alternatively may include a sealing component channel for receiving a corresponding sealing component 136.

In various examples, components of valve seal assembly 100 and/or of valve 10 may be described as being directly and/or sealingly engaged with one another, as being fluidly coupled to one another, and/or as featuring a fluid-tight seal therebetween even when such components do not directly contact one another. For example, a pair of components may be described as being directly and/or sealingly engaged with one another, as being fluidly coupled to one another, and/or as featuring a fluid-tight seal therebetween even when the components are operatively coupled to one another only via one or more sealing components 136 that are interposed between the components. For example, socket head 166 may be described as being directly and/or sealingly engaged with socket receiver 122 even in a configuration in which the socket head and the socket receiver are not in direct contact with one another but instead are sealingly engaged with a common sealing component 136 received within socket head sealing component channel 167.

As discussed, in some examples, and as schematically illustrated in FIG. 1 and less schematically illustrated in FIGS. 13-19, valve seal assembly 100 includes at least one expansion adapter seal plate 140 that is configured to be interposed between base seal plate 110 and valve 10 (shown in FIG. 1) during operative use of valve testing machine 50. In such examples, each expansion adapter seal plate 140 may include any of a variety of features and/or components for operatively engaging another component of valve seal assembly 100 and/or for facilitating the flow of the pressurized fluid therethrough.

In some examples, and as schematically illustrated in FIG. 1, expansion adapter seal plate 140 defines an expansion adapter seal plate central opening 150 that is aligned with and/or fluidly connected to seal plate fluid channel 114 during operative use of valve testing machine 50. Accordingly, in such examples and during operative use of valve testing machine 50 to test valve 10, the pressurized fluid flows to valve inlet 12 via each of seal plate fluid channel 114 of base seal plate 110 and expansion adapter seal plate central opening 150 of expansion adapter seal plate 140.

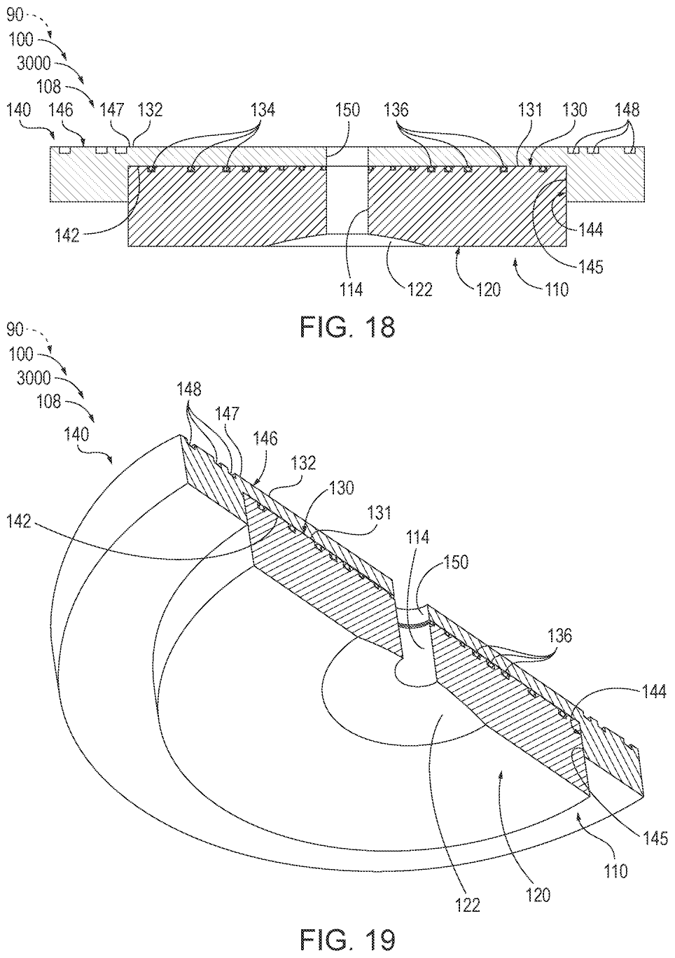

In some examples, such as in the examples of FIGS. 1 and 12-16, expansion adapter seal plate central opening 150 (labeled in FIGS. 1 and 14-16) has an inner diameter that is greater than an inner diameter of seal plate fluid channel 114 (labeled in FIGS. 1 and 14-16). In other examples, such as in the example of FIGS. 17-18, expansion adapter seal plate central opening 150 has an inner diameter that is at least substantially equal to the inner diameter of seal plate fluid channel 114. It further is within the scope of the present disclosure that expansion adapter seal plate central opening 150 may have an inner diameter that is less than the inner diameter of seal plate fluid channel 114.

As schematically illustrated in FIG. 1, each expansion adapter seal plate 140 may be described as including an expansion adapter seal plate first surface 142 and an expansion adapter seal plate second surface 146 opposite the expansion adapter seal plate first surface. Specifically, expansion adapter seal plate first surface 142 is configured to sealingly engage another component of seal plate structure 108 (such as base seal plate 110 or another expansion adapter seal plate 140), and expansion adapter seal plate second surface 146 is configured to engage valve 10 (and/or sealing flange 20 thereof) and/or another component of seal plate structure 108 (such as another expansion adapter seal plate 140). In some examples, expansion adapter seal plate first surface 142 also may be referred to as an expansion adapter seal plate lower surface 142, and/or expansion adapter seal plate second surface 146 also may be referred to as an expansion adapter seal plate upper surface 146.

As used herein, positional terms such as “upper,” “lower,” “top,” “bottom,” “above,” “below,” and the like generally are intended to refer to positional relationships as exhibited in a configuration in which valve testing machine 50 is in operative use to test valve 10 with the valve positioned above (e.g., supported by) seal plate structure 108, such that testing machine central axis 52 extends perpendicular to a ground surface. For example, and as schematically illustrated in FIG. 1, each clamp arm 62 of valve testing machine 50 may be described as being configured to extend above sealing flange 20 of valve 10 during operative use of valve testing machine 50. As another example, and as schematically illustrated in FIG. 1, force transfer member 160 may be described as being positioned below base seal plate 110 during operative use of valve testing machine 50. However, such descriptions are not limiting, and such descriptions are not intended to require that the corresponding components of valve seal assembly 100 always be in such an operative configuration and/or orientation.

Expansion adapter seal plate first surface 142 may include any of a variety of features and/or configurations for forming a fluid-tight seal with another component of seal plate structure 108. In some examples, and as schematically illustrated in FIG. 1 and less schematically illustrated in FIGS. 15-16 and 18-19, expansion adapter seal plate first surface 142 defines an expansion adapter seal plate receiver recess 144 that is configured to receive another component of seal plate structure 108, such as base seal plate 110 or another expansion adapter seal plate 140. Stated differently, in such examples, expansion adapter seal plate first surface 142 may include a recess, an annular recess, an indentation, etc. such that base seal plate 110 (and/or another component of seal plate structure 108) is at least partially received within expansion adapter seal plate 140 during operative use of valve testing machine 50. In particular, in some such examples, and as schematically illustrated in FIG. 1 and less schematically illustrated in FIGS. 15-16 and 18-19, expansion adapter seal plate receiver recess 144 includes at least a portion of expansion adapter seal plate first surface 142 as well as an expansion adapter seal plate inner wall 145 extending away from the expansion adapter seal plate first surface (e.g., along a direction at least substantially parallel to seal plate central axis 112, shown in FIG. 1). In such examples, expansion adapter seal plate 140 may be configured and/or sized such that the component that is received within expansion adapter seal plate receiver recess 144 engages each of expansion adapter seal plate first surface 142 and expansion adapter seal plate inner wall 145. In this manner, expansion adapter seal plate receiver recess 144 may provide for an increased surface area of engagement between the component received within the expansion adapter seal plate receiver recess and expansion adapter seal plate 140, and thus a more robust transfer of the sealing force from the component received within the expansion adapter seal plate receiver recess to the expansion adapter seal plate, relative to a configuration in which expansion adapter seal plate first surface 142 is substantially flat and/or otherwise lacks expansion adapter seal plate receiver recess 144.

Expansion adapter seal plate second surface 146 also may include any of a variety of features and/or configurations for forming a fluid-tight seal with valve 10 and/or with another component of seal plate structure 108 (e.g., another expansion adapter seal plate 140). In some examples, and as schematically illustrated in FIG. 1 and less schematically illustrated in FIGS. 13-19, expansion adapter seal plate second surface 146 includes an expansion adapter seal plate sealing interface 147. In particular, similar to base seal plate sealing interface 131, and as schematically illustrated in FIG. 1 and less schematically illustrated at least in FIGS. 15-17, expansion adapter seal plate sealing interface 147 may include a plurality of expansion adapter seal plate sealing component channels 148. In such examples, each expansion adapter seal plate sealing component channel 148 is configured to receive a corresponding sealing component 136 for forming a fluid-tight seal, such as with valve 10, with sealing flange 20, and/or with another component of seal plate structure 108 (e.g., with another expansion adapter seal plate 140). In some such examples, the plurality of expansion adapter seal plate sealing component channels 148 are at least substantially concentric with one another and feature varying respective diameters, such as to enable expansion adapter seal plate sealing interface 147 to form a fluid-tight seal with components of any of a corresponding variety of diameters.

In some examples, such as in second example seal assembly 2000 of FIGS. 12-16 and in third example seal plate assembly 3000 of FIGS. 17-19, seal plate structure 108 includes a single expansion adapter seal plate 140, such that expansion adapter seal plate sealing interface 147 of the single expansion adapter seal plate includes and/or is valve seal surface 132. However, as discussed and as schematically illustrated in FIG. 1, it additionally is within the scope of the present disclosure that seal plate structure 108 may include a plurality of expansion adapter seal plates 140 of progressively increasing diameters, such that the plurality of expansion adapter seal plates are stacked in order (from bottom to top) of increasing outer diameter during operative use of valve testing machine 50. In some such examples, each expansion adapter seal plate 140 of the plurality of expansion adapter seal plates includes a respective expansion adapter seal plate sealing interface 147, such that a fluid-tight seal is formed between each pair of adjacent expansion adapter seal plates 140 during operative use of valve testing machine 50. In such examples, configuring valve seal assembly 100 to be utilized in conjunction with valve testing machine 50 to test a particular valve 10 may include selecting a particular expansion adapter seal plate 140 (e.g., a single expansion adapter seal plate 140), or may include selecting an appropriate subset of the plurality of expansion adapter seal plates 140, such as based upon a dimension of the particular valve (e.g., a diameter of valve inlet 12 and/or of sealing flange 20 of the particular valve). Additionally or alternatively, in some examples, configuring valve seal assembly 100 to be utilized in conjunction with valve testing machine 50 to test a particular valve 10 may include selecting a particular base seal plate 110 from among a plurality of base seal plates 110 of varying dimensions (e.g., diameters), such as based upon a dimension of the particular valve (e.g., a diameter of valve inlet 12 and/or of sealing flange 20 of the particular valve).

As discussed, various aspects and/or features of valve seal assembly 100 may be described as offering a degree of modularity and/or versatility, such as to enable valve seal assembly 100 to be utilized in conjunction with any of a variety of differently sized valves 10. As an example, and as discussed, base seal plate 110 may be configured to be utilized in conjunction with one or more expansion adapter seal plates 140 when testing a particular valve 10 with a corresponding sealing flange 20 that is too large in diameter to form an effective fluid-tight seal with base seal plate second surface 130. Accordingly, in such an example, configuring valve seal assembly 100 to operatively engage the particular valve 10 may include selecting a particular expansion adapter seal plate 140, or a particular set of expansion adapter seal plates 140, that is/are appropriately sized for operative use with the particular valve 10.

As another example, and as discussed, base seal plate 110 may be configured to be utilized in conjunction with reduction adapter seal plate 102 when testing a particular valve 10 with a corresponding sealing flange 20 that is too small in diameter to form an effective fluid-tight seal with base seal plate second surface 130. Accordingly, in such an example, configuring valve seal assembly 100 to operatively engage the particular valve 10 may include selecting a particular reduction adapter seal plate 102 that is appropriately sized for operative use with the particular valve 10.

As yet another example, and as discussed, base seal plate 110 itself may be selected based on one or more dimensions thereof in order to form an effective fluid-tight seal with the corresponding sealing flange 20 of a particular valve 10. However, because base seal plate 110 may be restricted from removal from force transfer member 160 (e.g., by retaining ring 180, as described herein), it may be preferable to accommodate the dimensions of the particular valve 10 to be tested by utilizing expansion adapter seal plate(s) 140 or reduction adapter seal plate 102 as appropriate to provide an appropriately sized valve seal surface 132 without removing base seal plate 110 from force transfer member 160.

In all such examples, and as indicated in the Figures, various components of valve seal assembly 100 may be described as representing components of a valve seal assembly kit 90. For example, valve seal assembly kit 90 may include any components of valve seal assembly 100 disclosed herein, and/or may include pluralities of such components as appropriate to yield the modular functionality disclosed herein. As more specific examples, valve seal assembly kit 90 may include a single base seal plate 110, a plurality of differently dimensioned base seal plates 110, a single expansion adapter seal plate 140, a plurality of differently dimensioned expansion adapter seal plates 140, a single reduction adapter seal plate 102, a plurality of differently dimensioned reduction adapter seal plates 102, etc. Accordingly, in such examples, configuring valve seal assembly 100 for operative use in conjunction with a particular valve 10 may include selecting various components from valve seal assembly kit 90 to be assembled into seal plate structure 108.

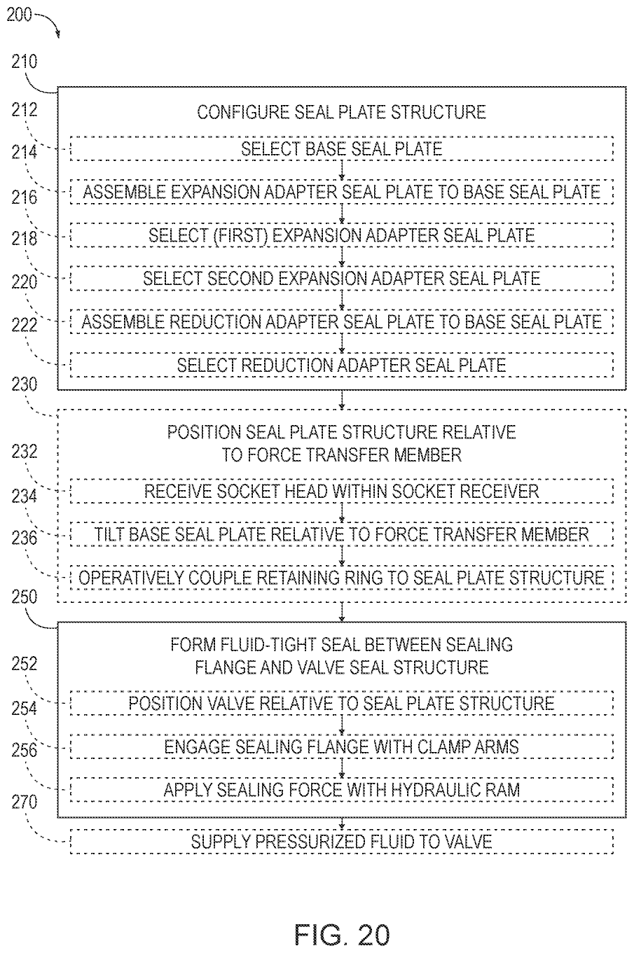

FIG. 20 is a flowchart representing examples of methods 200, according to the present disclosure, of utilizing a valve testing machine that includes a valve seal assembly to test a valve. Examples of valve testing machines, of valves, and/or of valve seal assemblies that may be utilized in conjunction with methods 200 are disclosed herein with reference to valve testing machine 50, valve 10, and/or valve seal assembly 100, respectively. As shown in FIG. 20, methods 200 include configuring, at 210, a seal plate structure for use to test the valve and forming, at 250, a fluid-tight seal between a sealing flange of the valve and a valve seal surface of the seal plate structure. Examples of seal plate structures, of sealing flanges, and/or of valve seal surfaces that may be utilized in conjunction with methods 200 are disclosed herein with reference to seal plate structure 108, sealing flange 20, and/or valve seal surface 132, respectively. In some examples, the forming the fluid-tight seal at 250 is performed subsequent to the configuring the seal plate structure at 210.

The configuring the seal plate structure at 210 may be performed in any of a variety of manners, such as to configure and/or adapt the seal plate structure for forming a fluid-tight seal with the sealing flange. Accordingly, in some examples, the configuring the seal plate structure at 210 is performed at least partially based upon one or more dimensions of the valve, such as an outer diameter of the sealing flange. In particular, in some examples, and as discussed, the seal plate structure may include a base seal plate (such as base seal plate 110 disclosed herein) that is not sufficiently large (e.g., in outer diameter) to form an effective fluid-tight seal with the sealing flange. Accordingly, in some examples, and as shown in FIG. 20, the configuring the seal plate structure at 210 includes assembling, at 214, an expansion adapter seal plate to the base seal plate. In particular, in some such examples, the assembling the expansion adapter seal plate to the base seal plate at 214 includes receiving the base seal plate within an expansion adapter seal plate receiver recess of the expansion adapter seal plate such that a base seal plate sealing interface of the base seal plate sealingly engages an expansion adapter seal plate first surface of the expansion adapter seal plate. Examples of expansion adapter seal plates, of expansion adapter seal plate receiver recesses, of base seal plate sealing interfaces, and/or of expansion adapter seal plate first surfaces that may be utilized in conjunction with methods 200 are disclosed herein with reference to expansion adapter seal plate 140, expansion adapter seal plate receiver recess 144, base seal plate sealing interface 131, and/or expansion adapter seal plate first surface 142, respectively.

In some examples, and as shown in FIG. 20, the configuring the seal plate structure at 210 additionally includes, prior to the assembling the expansion adapter seal plate to the base seal plate at 214, selecting, at 216, the expansion adapter seal plate to be utilized in the seal plate structure. For example, the selecting the expansion adapter seal plate at 216 may include selecting based upon one or more dimensions of the base seal plate and/or of the valve. As a more specific example, the selecting the expansion adapter seal plate at 216 may include selecting the expansion adapter seal plate such that the expansion adapter seal plate first surface of the expansion adapter seal plate is sized to sealingly engage the base seal plate and such that an expansion adapter seal plate second surface of the expansion adapter seal plate is sized to sealingly engage the sealing flange. Examples of expansion adapter seal plate second surfaces that may be utilized in conjunction with methods 200 are disclosed herein with reference to expansion adapter seal plate second surface 146.

In some examples, the configuring the seal plate structure at 210 includes selecting a plurality of expansion adapter seal plates, such as may be utilized in a stacked arrangement to adapt the base seal plate to the sealing flange of the valve to be tested. In particular, in some examples, and as shown in FIG. 20, the expansion adapter seal plate selected in the selecting the expansion adapter seal plate at 216 is a first expansion adapter seal plate, and the configuring the seal plate structure at 210 additionally includes selecting, at 218, a second expansion adapter seal plate. In some such examples, the selecting the second expansion adapter seal plate at 218 includes selecting the second expansion adapter seal plate such that the expansion adapter seal plate first surface of the second expansion adapter seal plate is sized to sealingly engage the expansion adapter seal plate second surface of the first expansion adapter seal plate. Additionally or alternatively, in some such examples, the selecting the second expansion adapter seal plate at 218 includes selecting the second expansion adapter seal plate such that the expansion adapter seal plate second surface of the second expansion adapter seal plate is sized to sealingly engage the sealing flange. In some examples, the configuring the seal plate structure at 210 may include repeating the selecting the second expansion adapter seal plate at 218 to select any suitable number of expansion adapter seal plates that are assembled to one another (e.g., in a stacked arrangement) in the seal plate structure.

In some examples, and as discussed, the seal plate structure may include a base seal plate that defines a seal plate fluid channel (such as seal plate fluid channel 114 disclosed herein) that is too large (e.g., in outer diameter) for the base seal plate to form an effective fluid-tight seal with the sealing flange. Accordingly, in some examples, and as shown in FIG. 20, the configuring the seal plate structure at 210 includes assembling, at 220, a reduction adapter seal plate to the base seal plate. In particular, in some such examples, the assembling the reduction adapter seal plate to the base seal plate at 220 includes inserting the reduction adapter seal plate at least partially into the seal plate fluid channel. In some such examples, and as shown in FIG. 20, methods 200 additionally include, prior to the assembling the reduction adapter seal plate to the base seal plate at 220, selecting, at 222, the reduction adapter seal plate to be utilized in the seal plate structure. For example, the assembling the reduction adapter seal plate to the base seal plate at 220 may include selecting based upon one or more dimensions of the base seal plate and/or of the valve.

Additionally or alternatively, in some examples, and as shown in FIG. 20, the configuring the seal plate structure at 210 includes selecting, at 212, the base seal plate, such as based upon one or more dimensions of the base seal plate and/or of the valve. For example, the selecting the base seal plate at 212 may include selecting such that the base seal plate sealing interface of the base seal plate is sized to sealingly engage the sealing flange of the valve.

In various examples, the configuring the seal plate structure at 210 includes utilizing a valve seal assembly kit, such as valve seal assembly kit 90 disclosed herein. In particular, in such examples, various steps of the configuring the seal plate structure at 210 may include selecting components from the valve seal assembly kit to form the seal plate structure. As a more specific example, the selecting the expansion adapter seal plate at 216 and/or the selecting the second expansion adapter seal plate at 218 may include selecting each expansion adapter seal plate from among a plurality of differently sized expansion adapter seal plates of the valve seal assembly kit. Similarly, the selecting the base seal plate at 212 may include selecting the base seal plate from among a plurality of differently sized base seal plates of the valve seal assembly kit, and/or the selecting the reduction adapter seal plate at 222 may include selecting the reduction adapter seal plate from among a plurality of differently sized reduction adapter seal plates of the valve seal assembly kit.

In some examples, and as shown in FIG. 20, methods 200 additionally include positioning, at 230, the seal plate structure relative to the force transfer member. In such examples, the positioning the seal plate structure relative to the force transfer member at 230 may be performed in any of a variety of manners. In some examples, the positioning the seal plate structure relative to the force transfer member at 230 is at least partially performed subsequent to the configuring the seal plate structure at 210. Additionally or alternatively, in some examples, the positioning the seal plate structure relative to the force transfer member at 230 is at least partially performed prior to the forming the fluid-tight seal at 250. In some examples, and as shown in FIG. 20, the positioning the seal plate structure relative to the force transfer member at 230 includes receiving, at 232, a socket head of the valve seal assembly (such as socket head 166 disclosed herein) within a socket receiver of the valve seal assembly (such as socket receiver 122 disclosed herein). As discussed herein, such a configuration may enable the base seal plate to tilt relative to the force transfer member, such as to enable the valve seal assembly to form a fluid-tight seal with the valve even when opposed surfaces of the sealing flange of the valve are not perfectly parallel to one another. Accordingly, in some such examples, and as shown in FIG. 20, the positioning the seal plate structure relative to the force transfer member at 230 includes tilting, at 234, the base seal plate relative to the force transfer member. Additionally or alternatively, in some examples, and as shown in FIG. 20, the positioning the seal plate structure relative to the force transfer member at 230 includes operatively coupling, at 236, a retaining ring to the seal plate structure, such as to restrict the base seal plate from being fully removed from the force transfer member. Examples of retaining rings that may be utilized in conjunction with methods 200 are disclosed herein with reference to retaining ring 180.

The forming the fluid-tight seal between the sealing flange and the valve seal surface at 250 may be performed in any of a variety of manners. In some examples, and as shown in FIG. 20, the forming the fluid-tight seal at 250 includes positioning, at 252, the valve relative to the seal plate structure. More specifically, in some such examples, the positioning the valve relative to the seal plate structure at 252 includes engaging the valve seal surface with the sealing flange. In some examples, the positioning the valve relative to the seal plate structure at 252 includes lowering the valve onto the assembled seal plate structure. Additionally or alternatively, in some examples, and as shown in FIG. 20, the forming the fluid-tight seal at 250 includes, subsequent to the positioning the valve relative to the seal plate structure at 252, engaging, at 254, the sealing flange with a plurality of clamp arms of the valve testing machine, such as clamp arms 62 disclosed herein. Additionally or alternatively, and as shown in FIG. 20, the forming the fluid-tight seal at 250 may include, subsequent to the positioning the valve relative to the seal plate structure at 252 and/or to the engaging the sealing flange with the plurality of clamp arms at 254, applying, at 256, a sealing force to the seal plate structure with a force exerting mechanism (such as force exerting mechanism 70 disclosed herein).

In some examples, and as shown in FIG. 20, methods 200 additionally include, subsequent to the forming the fluid-tight seal at 250, supplying, at 270, a pressurized fluid to the valve. In particular, in such examples, the supplying the pressurized fluid to the valve at 270 may include utilizing the valve testing machine to perform a pressure test of the valve. In such examples, the supplying the pressurized fluid to the valve at 270 may include supplying the pressurized fluid in any of a variety of manners. As examples, the supplying the pressurized fluid to the valve at 270 may include supplying the pressurized fluid at least partially via a fluid inlet of the force transfer member, a force transfer member fluid channel of the force transfer member, a seal plate fluid channel of the base seal plate, an expansion adapter seal plate central opening of the expansion adapter seal plate(s), and/or a reduction adapter seal plate fluid channel of the reduction adapter seal plate. Examples of fluid inlets, of force transfer member fluid channels, of seal plate fluid channels, of expansion adapters seal plate central openings, and/or of reduction adapter seal plate fluid channels that may be utilized in conjunction with methods 200 are disclosed herein with reference to fluid inlet 170, force transfer member fluid channel 164, seal plate fluid channel 114, expansion adapter seal plate central opening 150, and/or reduction adapter seal plate fluid channel 104, respectively.

Illustrative, non-exclusive examples of inventive subject matter according to the present disclosure are described in the following enumerated paragraphs:

A1. A valve seal assembly for operatively fluidly coupling a valve to a valve testing machine, the valve seal assembly comprising:

a seal plate structure with a valve seal surface configured to engage a sealing flange of the valve to form a fluid-tight seal with the sealing flange; and

a force transfer member with a force transfer member body configured to be operatively coupled to a force exerting mechanism of the valve testing machine.

A2. The valve seal assembly of paragraph A1, wherein the valve seal assembly is configured to convey a pressurized fluid to a valve inlet of the valve during operative use of the valve testing machine.

A3. The valve seal assembly of any of paragraphs A1-A2, wherein the force transfer member is configured to convey a sealing force from the force exerting mechanism to the seal plate structure during operative use of the valve testing machine.

A4. The valve seal assembly of any of paragraphs A1-A3, wherein one of the seal plate structure and the force transfer member includes a socket receiver opposite the valve seal surface; wherein the other of the seal plate structure and the force transfer member includes a socket head extending from the force transfer member body; and wherein, during operative use of the valve testing machine, the socket head is received within the socket receiver to convey a/the sealing force from the force exerting mechanism to the seal plate structure.

A5. The valve seal assembly of any of paragraphs A1-A4, wherein the seal plate structure includes a base seal plate with a base seal plate first surface and a base seal plate second surface opposite the base seal plate first surface; wherein the base seal plate second surface includes a base seal plate sealing interface that is configured to form a fluid-tight seal with one or both of:

(i) another component of the seal plate structure; and

(ii) the sealing flange.

A6. The valve seal assembly of any of paragraphs A1-A5, wherein the force transfer member body defines a fluid inlet for receiving a flow of a/the pressurized fluid.

A7. The valve seal assembly of any of paragraphs A1-A6, wherein the force transfer member defines a force transfer member fluid channel for conveying a/the pressurized fluid through the force transfer member.

A8. The valve seal assembly of any of paragraphs A1-A7, when dependent from paragraph A5, wherein the base seal plate defines at least a portion of a seal plate fluid channel extending through at least a portion of the seal plate structure.

A9. The valve seal assembly of paragraph A8, wherein the base seal plate defines an entirety of the seal plate fluid channel.

A10. The valve seal assembly of any of paragraphs A1-A9, when dependent from paragraphs A7 and A8, wherein, during operative use of the valve testing machine, the force transfer member fluid channel is at least partially aligned with the seal plate fluid channel to permit the pressurized fluid to flow from a/the fluid inlet into a/the valve inlet via the force transfer member fluid channel and the seal plate fluid channel.

A11. The valve seal assembly of any of paragraphs A1-A10, when dependent from paragraphs A4, A7, and A8, wherein the seal plate structure defines a seal plate central axis that is perpendicular to the valve seal surface; wherein the force transfer member extends along and defines a force transfer member central axis; and wherein the valve seal assembly is configured such that the force transfer member fluid channel and the seal plate fluid channel are fluidly connected when the socket head is operatively received within the socket receiver and when either of:

(i) the seal plate central axis and the force transfer member central axis are collinear; or

(ii) the seal plate central axis and the force transfer member central axis are angled relative to one another by at most a threshold offset angle.

A12. The valve seal assembly of paragraph A11, wherein the threshold offset angle is one or more of at least 1 degree, at least 3 degrees, at least 5 degrees, at most 10 degrees, at most 7 degrees, and at most 2 degrees.

A13. The valve seal assembly of any of paragraphs A1-A12, wherein a/the fluid inlet is configured to receive a fluid flow of a/the pressurized fluid along a direction that is oblique to a/the force transfer member central axis.

A14. The valve seal assembly of any of paragraphs A1-A13, wherein a/the fluid inlet is configured to receive a/the fluid flow along a direction that is angled relative to a/the force transfer member central axis by an inlet angle that is one or more of at least 10 degrees, at least 20 degrees, at least 30 degrees, at least 40 degrees, at least 50 degrees, at least 60 degrees, at least 70 degrees, at most 75 degrees, at most 65 degrees, at most 55 degrees, at most 45 degrees, at most 35 degrees, at most 25 degrees, and at most 15 degrees.

A15. The valve seal assembly of any of paragraphs A1-A14, when dependent from paragraph A4, wherein the socket head is a convex socket head; and wherein the socket receiver is a concave socket receiver that is configured to receive the socket head in any of a plurality of distinct orientations.

A16. The valve seal assembly of any of paragraphs A1-A15, when dependent from paragraph A4, wherein one or both of the socket head and the socket receiver is at least substantially spherical in shape.

A17. The valve seal assembly of any of paragraphs A1-A16, when dependent from paragraph A4, wherein the valve seal assembly is configured such that the seal plate structure may shift relative to the force transfer member while the socket head is operatively received within the socket receiver.

A18. The valve seal assembly of any of paragraphs A1-A17, when dependent from paragraph A4, wherein the valve seal assembly includes one or more sealing components for forming a fluid-tight seal between two or more components of the valve seal assembly; and wherein one of the socket head and the socket receiver includes a socket head sealing component channel configured to receive a corresponding sealing component of the one or more sealing components for forming a fluid-tight seal against the other of the socket head and the socket receiver.

A19. The valve seal assembly of paragraph A18, wherein each sealing component of the one or more sealing components includes, and optionally is, one or more of an O-ring, a sealing gasket, a ring type joint, and a sealing surface.

A20. The valve seal assembly of any of paragraphs A1-A19, when dependent from paragraph A4, wherein the socket head has a diameter, as measured along a direction perpendicular to a/the force transfer member central axis, that is greater than a diameter of the force transfer member body.

A21. The valve seal assembly of any of paragraphs A1-A20, when dependent from paragraph A4, wherein the force transfer member fluid channel extends between a/the fluid inlet and the socket head.

A22. The valve seal assembly of any of paragraphs A1-A21, when dependent from paragraph A4, wherein a/the seal plate fluid channel extends at least partially between the socket receiver and the valve seal surface.

A23. The valve seal assembly of any of paragraphs A1-A22, wherein the valve seal assembly further includes a retaining ring that is configured to restrict the seal plate structure from being fully removed from the force transfer member during operative use of the valve testing machine.

A24. The valve seal assembly of paragraph A23, when dependent from paragraph A12, wherein the retaining ring is configured to be selectively and operatively coupled to the seal plate structure during operative use of the valve testing machine, optionally via one or more retaining ring mechanical fasteners; and wherein the retaining ring defines a retaining ring recess that is configured to receive a portion of the socket head while the retaining ring is operatively coupled to the seal plate structure to restrict the seal plate structure from being removed from the force transfer member during operative use of the valve testing machine.

A25. The valve seal assembly of any of paragraphs A1-A24, when dependent from paragraph A5, wherein the base seal plate sealing interface is configured to form a fluid-tight seal with one or both of:

(i) another component of the seal plate structure; and

(ii) the sealing flange.

A26. The valve seal assembly of any of paragraphs A1-A25, when dependent from paragraph A5, wherein the base seal plate first surface is configured to face toward the force transfer member during operative use of the valve testing machine.

A27. The valve seal assembly of any of paragraphs A1-A26, when dependent from paragraph A5, wherein the base seal plate first surface includes a/the socket receiver.

A28. The valve seal assembly of any of paragraphs A1-A27, when dependent from paragraph A5, wherein the base seal plate sealing interface includes a plurality of base seal plate sealing component channels, each configured to receive a corresponding sealing component of an/the one or more sealing components.

A29. The valve seal assembly of any of paragraphs A1-A28, when dependent from paragraph A5, wherein the base seal plate sealing interface includes, and optionally is, the valve seal surface.

A30. The valve seal assembly of any of paragraphs A1-A29, wherein the seal plate structure further includes an expansion adapter seal plate with an expansion adapter seal plate first surface and an expansion adapter seal plate second surface opposite the expansion adapter seal plate first surface; optionally wherein the expansion adapter seal plate first surface is configured to sealingly engage another component of the seal plate structure, optionally the base seal plate, during operative use of the valve testing machine; and wherein the expansion adapter seal plate second surface includes an expansion adapter seal plate sealing interface that is configured to form a fluid-tight seal with one or both of:

(i) another component of the seal plate structure; and

(ii) the sealing flange.

A31. The valve seal assembly of paragraph A30, wherein the expansion adapter seal plate has an outer diameter that is greater than an outer diameter of the base seal plate.

A32. The valve seal assembly of any of paragraphs A30-A31, wherein the expansion adapter seal plate sealing interface includes a plurality of expansion adapter seal plate sealing component channels, each configured to receive a corresponding sealing component of a/the one or more sealing components for forming a fluid-tight seal between the expansion adapter seal plate and one or both of:

(i) another component of the seal plate structure; and

(ii) the sealing flange.

A33. The valve seal assembly of any of paragraphs A30-A32, wherein the expansion adapter seal plate sealing interface includes, and optionally is, the valve seal surface.

A34. The valve seal assembly of any of paragraphs A30-A33, wherein the expansion adapter seal plate first surface defines an expansion adapter seal plate receiver recess that is configured to receive at least a portion of another component of the seal plate structure, optionally the base seal plate, during operative use of the valve testing machine.

A35. The valve seal assembly of paragraph A34, wherein the expansion adapter seal plate receiver recess includes:

at least a portion of the expansion adapter seal plate first surface; and

an expansion adapter seal plate inner wall extending away from the expansion adapter seal plate first surface.

A36. The valve seal assembly of paragraph A35, wherein the expansion adapter seal plate inner wall extends away from the expansion adapter seal plate first surface along a direction at least substantially parallel to a/the seal plate central axis.

A37. The valve seal assembly of any of paragraphs A35-A36, wherein the expansion adapter seal plate is configured such that the other component of the seal plate structure that is received within the expansion adapter seal plate receiver recess engages each of the expansion adapter seal plate first surface and the expansion adapter seal plate inner wall during operative use of the valve testing machine.

A38. The valve seal assembly of any of paragraphs A30-A37, wherein the expansion adapter seal plate defines an expansion adapter seal plate central opening that is one or both of aligned with and fluidly connected to a/the seal plate fluid channel during operative use of the valve testing machine.

A39. The valve seal assembly of paragraph A38, wherein the expansion adapter seal plate central opening has an inner diameter that is at least substantially equal to an inner diameter of the seal plate fluid channel.

A40. The valve seal assembly of paragraph A38, wherein the expansion adapter seal plate central opening has an inner diameter that is greater than an inner diameter of the seal plate fluid channel.

A41. The valve seal assembly of any of paragraphs A30-A40, wherein the expansion adapter seal plate is a first expansion adapter seal plate of a plurality of expansion adapter seal plates.

A42. The valve seal assembly of paragraph A41, wherein the valve seal assembly is configured such that the plurality of expansion adapter seal plates are stacked in order of increasing diameter during operative use of the valve testing machine.

A43. The valve seal assembly of any of paragraphs A41-A42, wherein each expansion adapter seal plate of the plurality of expansion adapter seal plates includes a respective expansion adapter seal plate first surface and a respective expansion adapter seal plate second surface opposite the respective expansion adapter seal plate first surface; and wherein the respective expansion adapter seal plate second surface of each expansion adapter seal plate of the plurality of expansion adapter seal plates includes an/the expansion adapter seal plate sealing interface.

A44. The valve seal assembly of any of paragraphs A1-A43, wherein the seal plate structure further includes a reduction adapter seal plate that is configured to be at least partially received within the base seal plate, optionally within the seal plate fluid channel, during operative use of the valve testing machine; and wherein the reduction adapter seal plate includes at least a portion of the valve seal surface.

A45. The valve seal assembly of paragraph A44, wherein the reduction adapter seal plate defines a reduction adapter seal plate fluid channel that is one or both of aligned with and fluidly connected to the seal plate fluid channel during operative use of the valve testing machine.

A46. The valve seal assembly of any of paragraphs A1-A45, wherein the force transfer member is configured to be fixedly coupled to the force exerting mechanism during operative use of the valve testing machine; and optionally wherein the valve seal assembly includes one or more force transfer member mechanical fasteners configured to fixedly couple the force transfer member to the force exerting mechanism.

B1. A valve testing machine comprising the valve seal assembly of any of paragraphs A1-A46.

B2. The valve testing machine of paragraph B1, wherein the valve includes a pressure relief outlet; and wherein the valve testing machine is configured to test a performance of the valve to divert at least a portion of a flow of a pressurized fluid to the pressure relief outlet when a pressure of the pressurized fluid exceeds a threshold operative fluid pressure.

B3. The valve testing machine of paragraph B2, wherein the pressurized fluid includes one or more of a liquid, water, a gas, air, and nitrogen.

B4. The valve testing machine of any of paragraphs B1-B3, wherein the valve testing machine includes a machine base and a plurality of clamp arms operatively coupled to the machine base and configured to engage the sealing flange; wherein the sealing flange includes a first flange surface configured to engage the valve seal assembly and a second flange surface opposite the first flange surface and configured to engage each clamp arm of the plurality of clamp arms; and wherein, during operative use of the valve testing machine, the valve seal surface engages the first flange surface of the sealing flange and each clamp arm of the plurality of clamp arms engages the second flange surface of the sealing flange such that applying a/the sealing force to the valve seal assembly urges the seal plate structure into fluid-tight engagement with the first flange surface.

B5. The valve testing machine of any of paragraphs B1-B4, wherein the valve testing machine defines a testing machine central axis; and wherein the force exerting mechanism is configured to translate along the testing machine central axis to apply a/the sealing force.

C1. A valve seal assembly kit comprising the valve seal assembly of any of paragraphs A1-A46.

D1. A method of utilizing a valve testing machine comprising the valve seal assembly of any of paragraphs A1-A46 to test a valve, the method comprising:

configuring the seal plate structure for use to test the valve; and

forming the fluid-tight seal between the sealing flange and the valve seal surface.

D2. The method of paragraph D1, wherein the forming the fluid-tight seal between the sealing flange and the valve seal interface is performed subsequent to the configuring the seal plate structure for use to test the valve.

D3. The method of any of paragraphs D1-D2, wherein the configuring the seal plate structure includes assembling an/the expansion adapter seal plate to the base seal plate.

D4. The method of paragraph D3, wherein the assembling the expansion adapter seal plate to the base seal plate includes receiving the base seal plate within an/the expansion adapter seal plate receiver recess such that a/the base seal plate sealing interface sealingly engages an/the expansion adapter seal plate first surface of the expansion adapter seal plate.

D5. The method of any of paragraphs D3-D4, wherein the configuring the seal plate structure includes, prior to the assembling the expansion adapter seal plate to the base seal plate, selecting the expansion adapter seal plate to be utilized in the seal plate structure.

D6. The method of paragraph D5, wherein the selecting the expansion adapter seal plate includes selecting such that an/the expansion adapter seal plate first surface of the expansion adapter seal plate is sized to sealingly engage the base seal plate and such that an/the expansion adapter seal plate second surface of the expansion adapter seal plate is sized to sealingly engage the sealing flange.

D7. The method of any of paragraphs D1-D6, wherein the expansion adapter seal plate is a/the first expansion adapter seal plate of a/the plurality of expansion adapter seal plates; and wherein the configuring the seal plate structure additionally includes selecting a/the second expansion adapter seal plate of the plurality of expansion adapter seal plates.

D8. The method of paragraph D7, wherein the selecting the second expansion adapter seal plate includes selecting such that one or both of:

(i) an/the expansion adapter seal plate first surface of the second expansion adapter seal plate is sized to sealingly engage an/the expansion adapter seal plate second surface of the first expansion adapter seal plate; and

(ii) the expansion adapter seal plate second surface of the second expansion adapter seal plate is sized to sealingly engage the sealing flange.

D9. The method of any of paragraphs D1-D8, wherein one or more of a/the selecting the expansion adapter seal plate, a/the selecting the first expansion adapter seal plate, and a/the selecting the second expansion adapter seal plate includes selecting from a valve seal assembly kit.

D10. The method of any of paragraphs D1-D9, wherein the configuring the seal plate structure includes assembling a/the reduction adapter seal plate to the base seal plate.

D11. The method of paragraph D10, wherein the assembling the reduction adapter seal plate to the base seal plate includes inserting the reduction adapter seal plate at least partially into a/the seal plate fluid channel.

D12. The method of any of paragraphs D10-D11, wherein the configuring the seal plate structure includes, prior to the assembling the reduction adapter seal plate to the base seal plate, selecting the reduction adapter seal plate to be utilized in the seal plate structure.

D13. The method of paragraph D12, wherein the selecting the reduction adapter seal plate includes selecting from a/the valve seal assembly kit.

D14. The method of any of paragraphs D1-D13, wherein the configuring the seal plate structure includes selecting the base seal plate.

D15. The method of paragraph D14, wherein the selecting the base seal plate includes selecting such that a/the base seal plate sealing interface is sized to sealingly engage the sealing flange.

D16. The method of any of paragraphs D1-D15, wherein the forming the fluid-tight seal between the sealing flange and the valve seal surface includes positioning the valve relative to the seal plate structure.

D17. The method of paragraph D16, wherein the positioning the valve relative to the seal plate structure includes engaging the valve seal surface with the sealing flange.

D18. The method of any of paragraphs D16-D17, wherein the positioning the valve relative to the seal plate structure includes lowering the valve onto the seal plate structure.

D19. The method of any of paragraphs D16-D18, wherein the valve testing machine includes a machine base and a plurality of clamp arms operatively coupled to the machine base and configured to engage the sealing flange; wherein the sealing flange includes a first flange surface configured to engage the valve seal assembly and a second flange surface opposite the first flange surface and configured to engage each clamp arm of the plurality of clamp arms; wherein, during operative use of the valve testing machine, the valve seal surface engages the first flange surface of the sealing flange and each clamp arm of the plurality of clamp arms engages the second flange surface of the sealing flange such that applying a/the sealing force to the valve seal assembly urges the seal plate structure into fluid-tight engagement with the first flange surface; and wherein the forming the fluid-tight seal between the sealing flange and the valve seal surface includes, subsequent to the positioning the valve relative to the seal plate structure, engaging the sealing flange with the plurality of clamp arms.

D20. The method of any of paragraphs D16-D19, wherein the forming the fluid-tight seal between the sealing flange and the valve seal surface includes, subsequent to one or both of the positioning the valve relative to the seal plate structure and an/the engaging a/the sealing flange with a/the plurality of clamp arms, applying a/the sealing force with a/the force exerting mechanism.

D21. The method of any of paragraphs D1-D20, further comprising positioning the seal plate structure relative to the force transfer member.

D22. The method of paragraph D21, wherein the positioning the seal plate structure relative to the force transfer member is at least partially performed subsequent to the configuring the seal plate structure.

D23. The method of any of paragraphs D21-D22, wherein the positioning the seal plate structure relative to the force transfer member is at least partially performed prior to the forming the fluid-tight seal between the sealing flange and the valve seal surface.

D24. The method of any of paragraphs D21-D23, wherein the positioning the seal plate structure relative to the force transfer member includes receiving a/the socket head within a/the socket receiver.

D25. The method of any of paragraphs D21-D24, wherein the positioning the seal plate structure relative to the force transfer member includes tilting the base seal plate relative to the force transfer member.

D26. The method of any of paragraphs D21-D25, wherein the positioning the seal plate structure relative to the force transfer member includes operatively coupling a/the retaining ring to the seal plate structure.

D27. The method of any of paragraphs D1-D26, further comprising, subsequent to the forming the fluid-tight seal between the sealing flange and the valve seal surface, supplying the pressurized fluid to the valve.

D28. The method of paragraph D27, wherein the supplying the pressurized fluid to the valve includes supplying the pressurized fluid at least partially via one or more of a/the fluid inlet of the force transfer member, a/the force transfer member fluid channel, a/the seal plate fluid channel, an/the expansion adapter seal plate central opening, and a/the reduction adapter seal plate fluid channel.

As used herein, the terms “adapted” and “configured” mean that the element, component, or other subject matter is designed and/or intended to perform a given function. Thus, the use of the terms “adapted” and “configured” should not be construed to mean that a given element, component, or other subject matter is simply “capable of” performing a given function but that the element, component, and/or other subject matter is specifically selected, created, implemented, utilized, programmed, and/or designed for the purpose of performing the function. It is also within the scope of the present disclosure that elements, components, and/or other recited subject matter that is recited as being adapted to perform a particular function may additionally or alternatively be described as being configured to perform that function, and vice versa. Similarly, subject matter that is recited as being configured to perform a particular function may additionally or alternatively be described as being operative to perform that function.

As used herein, the term “and/or” placed between a first entity and a second entity means one of (1) the first entity, (2) the second entity, and (3) the first entity and the second entity. Multiple entries listed with “and/or” should be construed in the same manner, i.e., “one or more” of the entities so conjoined. Other entities optionally may be present other than the entities specifically identified by the “and/or” clause, whether related or unrelated to those entities specifically identified. Thus, as a non-limiting example, a reference to “A and/or B,” when used in conjunction with open-ended language such as “comprising,” may refer, in one example, to A only (optionally including entities other than B); in another example, to B only (optionally including entities other than A); in yet another example, to both A and B (optionally including other entities). These entities may refer to elements, actions, structures, steps, operations, values, and the like.

As used herein, the phrase “at least one,” in reference to a list of one or more entities should be understood to mean at least one entity selected from any one or more of the entities in the list of entities, but not necessarily including at least one of each and every entity specifically listed within the list of entities and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the phrase “at least substantially,” when modifying a degree or relationship, includes not only the recited “substantial” degree or relationship, but also the full extent of the recited degree or relationship. A substantial amount of a recited degree or relationship may include at least 75% of the recited degree or relationship. For example, a first component that extends at least substantially around a second component includes a first component that extends around at least 75% of a circumference of the second component and also includes a first component that extends fully circumferentially around the second component.

As used herein, the phrase, “for example,” the phrase, “as an example,” and/or simply the term “example,” when used with reference to one or more components, features, details, structures, embodiments, and/or methods according to the present disclosure, are intended to convey that the described component, feature, detail, structure, embodiment, and/or method is an illustrative, non-exclusive example of components, features, details, structures, embodiments, and/or methods according to the present disclosure. Thus, the described component, feature, detail, structure, embodiment, and/or method is not intended to be limiting, required, or exclusive/exhaustive; and other components, features, details, structures, embodiments, and/or methods, including structurally and/or functionally similar and/or equivalent components, features, details, structures, embodiments, and/or methods, are also within the scope of the present disclosure.

The various disclosed elements of apparatuses disclosed herein are not required to all apparatuses according to the present disclosure, and the present disclosure includes all novel and non-obvious combinations and subcombinations of the various elements disclosed herein. Moreover, one or more of the various elements disclosed herein may define independent inventive subject matter that is separate and apart from the whole of a disclosed apparatus. Accordingly, such inventive subject matter is not required to be associated with the specific apparatuses that are expressly disclosed herein, and such inventive subject matter may find utility in apparatuses and/or methods that are not expressly disclosed herein.

It is believed that the disclosure set forth above encompasses multiple distinct inventions with independent utility. While each of these inventions has been disclosed in its preferred form, the specific embodiments thereof as disclosed and illustrated herein are not to be considered in a limiting sense as numerous variations are possible. The subject matter of the inventions includes all novel and non-obvious combinations and subcombinations of the various elements, features, functions and/or properties disclosed herein. Similarly, where the claims recite “a” or “a first” element or the equivalent thereof, such claims should be understood to include incorporation of one or more such elements, neither requiring nor excluding two or more such elements.

It is believed that the following claims particularly point out certain combinations and subcombinations that are directed to one of the disclosed inventions and are novel and non-obvious. Inventions embodied in other combinations and subcombinations of features, functions, elements, and/or properties may be claimed through amendment of the present claims or presentation of new claims in this or a related application. Such amended or new claims, whether they are directed to a different invention or directed to the same invention, whether different, broader, narrower, or equal in scope to the original claims, are also regarded as included within the subject matter of the inventions of the present disclosure.

1. A valve seal assembly for operatively fluidly coupling a valve to a valve testing machine, the valve seal assembly comprising:
a seal plate structure with a valve seal surface configured to engage a sealing flange of the valve to form a fluid-tight seal with the sealing flange; and
a force transfer member with a force transfer member body configured to be operatively coupled to a force exerting mechanism of the valve testing machine;
wherein the seal plate structure includes:
a base seal plate with a base seal plate first surface and a base seal plate second surface opposite the base seal plate first surface; and
an expansion adapter seal plate with an expansion adapter seal plate first surface and an expansion adapter seal plate second surface opposite the expansion adapter seal plate first surface;
wherein the base seal plate second surface includes a base seal plate sealing interface that is configured to form a fluid-tight seal with the expansion adapter seal plate first surface; and wherein the expansion adapter seal plate second surface includes an expansion adapter seal plate sealing interface that is configured to form a fluid-tight seal with one or both of:
(i) another component of the seal plate structure; and
(ii) the sealing flange.

2. The valve seal assembly of claim 1, wherein the expansion adapter seal plate has an outer diameter that is greater than an outer diameter of the base seal plate.

3. The valve seal assembly of claim 1, wherein the expansion adapter seal plate first surface defines an expansion adapter seal plate receiver recess that is configured to receive at least a portion of the base seal plate during operative use of the valve testing machine; wherein the expansion adapter seal plate receiver recess includes:
at least a portion of the expansion adapter seal plate first surface; and
an expansion adapter seal plate inner wall extending away from the expansion adapter seal plate first surface; and
wherein the expansion adapter seal plate is configured such that the portion of the base seal plate that is received within the expansion adapter seal plate receiver recess engages each of the expansion adapter seal plate first surface and the expansion adapter seal plate inner wall during operative use of the valve testing machine.

4. The valve seal assembly of claim 1, wherein the base seal plate defines at least a portion of a seal plate fluid channel extending through at least a portion of the seal plate structure; and wherein the expansion adapter seal plate defines an expansion adapter seal plate central opening that is one or both of aligned with and fluidly connected to the seal plate fluid channel during operative use of the valve testing machine.

5. The valve seal assembly of claim 1, wherein the expansion adapter seal plate is a first expansion adapter seal plate of a plurality of expansion adapter seal plates; and wherein the valve seal assembly is configured such that the plurality of expansion adapter seal plate are stacked in order of increasing diameter during operative use of the valve testing machine.

6. The valve seal assembly of claim 5, wherein each expansion adapter seal plate of the plurality of expansion adapter seal plates includes a respective expansion adapter seal plate first surface and a respective expansion adapter seal plate second surface opposite the respective expansion adapter seal plate first surface; and wherein the respective expansion adapter seal plate second surface of each expansion adapter seal plate of the plurality of expansion adapter seal plates includes the expansion adapter seal plate sealing interface.

7. The valve seal assembly of claim 1, wherein the seal plate structure further includes a reduction adapter seal plate that is configured to be at least partially received within the base seal plate during operative use of the valve testing machine; and wherein the reduction adapter seal plate includes at least a portion of the valve seal surface.

8. The valve seal assembly of claim 7, wherein the base seal plate defines at least a portion of a seal plate fluid channel extending through at least a portion of the seal plate structure; and wherein the reduction adapter seal plate defines a reduction adapter seal plate fluid channel that is one or both of aligned with and fluidly connected to the seal plate fluid channel during operative use of the valve testing machine.

9. The valve seal assembly of claim 1, wherein one of the seal plate structure and the force transfer member includes a socket receiver opposite the valve seal surface; wherein the other of the seal plate structure and the force transfer member includes a socket head extending from the force transfer member body; wherein, during operative use of the valve testing machine, the socket head is received within the socket receiver to convey a sealing force from the force exerting mechanism to the seal plate structure; wherein the valve seal assembly is configured to convey a pressurized fluid to a valve inlet of the valve during operative use of the valve testing machine; wherein the force transfer member defines a force transfer member fluid channel for conveying the pressurized fluid through the force transfer member; wherein the base seal plate defines at least a portion of a seal plate fluid channel extending through at least a portion of the seal plate structure; and wherein, during operative use of the valve testing machine, the force transfer member fluid channel is at least partially aligned with the seal plate fluid channel to permit the pressurized fluid to flow from the fluid inlet into the valve inlet via the force transfer member fluid channel and the seal plate fluid channel.

10. A valve testing machine, comprising:
a machine base;
a plurality of clamp arms operatively coupled to the machine base and configured to engage a sealing flange of a valve; and
the valve seal assembly of claim 1;
wherein the force transfer member is configured to convey a sealing force from the force exerting mechanism to the seal plate structure during operative use of the valve testing machine; wherein the sealing flange includes a first flange surface configured to engage the valve seal assembly and a second flange surface opposite the first flange surface and configured to engage each clamp arm of the plurality of clamp arms; and wherein, during operative use of the valve testing machine, the valve seal surface engages the first flange surface of the sealing flange and each clamp arm of the plurality of clamp arms engages the second flange surface of the sealing flange such that applying the sealing force to the valve seal assembly urges the seal plate structure into fluid-tight engagement with the first flange surface.

11. A method of utilizing a valve testing machine comprising the valve seal assembly of claim 1 to test a valve, the method comprising:
configuring the seal plate structure for use to test the valve; and
forming the fluid-tight seal between the sealing flange and the valve seal surface;
wherein the configuring the seal plate structure includes assembling the expansion adapter seal plate to the base seal plate.

12. The method of claim 11, wherein the configuring the seal plate structure includes, prior to the assembling the expansion adapter seal plate to the base seal plate, selecting the expansion adapter seal plate to be utilized in the seal plate structure; and wherein the selecting the expansion adapter seal plate includes selecting such that the expansion adapter seal plate first surface of the expansion adapter seal plate is sized to sealingly engage the base seal plate and such that the expansion adapter seal plate second surface of the expansion adapter seal plate is sized to sealingly engage the sealing flange.

13. The method of claim 11, wherein the expansion adapter seal plate is a first expansion adapter seal plate of a plurality of expansion adapter seal plates; and wherein the configuring the seal plate structure additionally includes selecting a second expansion adapter seal plate of the plurality of expansion adapter seal plates such that one or both of:
(i) the expansion adapter seal plate first surface of the second expansion adapter seal plate is sized to sealingly engage the expansion adapter seal plate second surface of the first expansion adapter seal plate; and
(ii) the expansion adapter seal plate second surface of the second expansion adapter seal plate is sized to sealingly engage the sealing flange.

14. The method of claim 11, wherein the seal plate structure further includes a reduction adapter seal plate that is configured to be at least partially received within the base seal plate during operative use of the valve testing machine; wherein the reduction adapter seal plate includes at least a portion of the valve seal surface; wherein the base seal plate defines at least a portion of a seal plate fluid channel extending through at least a portion of the seal plate structure; and wherein the configuring the seal plate structure includes assembling the reduction adapter seal plate to the base seal plate by inserting the reduction adapter seal plate at least partially into the seal plate fluid channel.

15. The method of claim 14, wherein the configuring the seal plate structure includes, prior to the assembling the reduction adapter seal plate to the base seal plate, selecting the reduction adapter seal plate to be utilized in the seal plate structure such that the base seal plate sealing interface is sized to sealingly engage the sealing flange.

16. A valve seal assembly for operatively fluidly coupling a valve to a valve testing machine, the valve seal assembly comprising:
a seal plate structure with a valve seal surface configured to engage a sealing flange of the valve to form a fluid-tight seal with the sealing flange; and
a force transfer member with a force transfer member body configured to be operatively coupled to a force exerting mechanism of the valve testing machine;
wherein the seal plate structure includes a base seal plate with a base seal plate first surface and a base seal plate second surface opposite the base seal plate first surface; wherein the base seal plate second surface includes a base seal plate sealing interface that is configured to form a fluid-tight seal with another component; wherein one of the seal plate structure and the force transfer member includes a socket receiver opposite the valve seal surface; wherein the other of the seal plate structure and the force transfer member includes a socket head extending from the force transfer member body; wherein, during operative use of the valve testing machine, the socket head is received within the socket receiver to convey a sealing force from the force exerting mechanism to the seal plate structure; wherein the valve seal assembly is configured to convey a pressurized fluid to a valve inlet of the valve during operative use of the valve testing machine; wherein the force transfer member defines a force transfer member fluid channel for conveying the pressurized fluid through the force transfer member; wherein the base seal plate defines at least a portion of a seal plate fluid channel extending through at least a portion of the seal plate structure; and wherein, during operative use of the valve testing machine, the force transfer member fluid channel is at least partially aligned with the seal plate fluid channel to permit the pressurized fluid to flow from the fluid inlet into the valve inlet via the force transfer member fluid channel and the seal plate fluid channel.

17. The valve seal assembly of claim 16, wherein the socket head is a convex socket head; and wherein the socket receiver is a concave socket receiver that is configured to receive the socket head in any of a plurality of distinct orientations.

18. The valve seal assembly of claim 16, wherein the seal plate structure defines a seal plate central axis that is perpendicular to the valve seal surface; wherein the force transfer member extends along and defines a force transfer member central axis; and wherein the valve seal assembly is configured such that the force transfer member fluid channel and the seal plate fluid channel are fluidly connected when the socket head is operatively received within the socket receiver and when either of:
(i) the seal plate central axis and the force transfer member central axis are collinear; or
(ii) the seal plate central axis and the force transfer member central axis are angled relative to one another by at most a threshold offset angle that is at least 3 degrees.

19. The valve seal assembly of claim 16, wherein the force transfer member extends along and defines a force transfer member central axis; wherein the force transfer member body defines a fluid inlet for receiving a flow of the pressurized fluid; and wherein the fluid inlet is configured to receive a fluid flow of the pressurized fluid along a direction that is angled relative to the force transfer member central axis by an inlet angle that is at least 10 degrees and at most 75 degrees.

20. The valve seal assembly of claim 16, wherein the force transfer member extends along and defines a force transfer member central axis; and wherein the socket head has a diameter, as measured along a direction perpendicular to the force transfer member central axis, that is greater than a diameter of the force transfer member body.
